(19) United States
(12) Patent Application Publication
(10) Pub. No.: US 2026/0225667 A1
(43) Pub. Date: Aug. 6, 2026

(54) SIDE SILL STRUCTURE

(71) Applicant: Kabushiki Kaisha Kobe Seiko Sho (Kobe Steel, Ltd.), Kobe-shi (JP)

(72) Inventors: Sadao MIYAZAWA, Kobe-shi (JP); Kenichi WATANABE, Kobe-shi (JP); Artur REKETS, Kobe-shi (JP)

(73) Assignee: Kabushiki Kaisha Kobe Seiko Sho (Kobe Steel, Ltd.), Kobe-shi (JP)

(21) Appl. No.: 19/147,830

(22) PCT Filed: Dec. 14, 2023
(86) PCT No.: PCT/JP2023/044827

§ 371 Date: Jul. 14, 2025

(30) Foreign Application Priority Data
Feb. 6, 2023 (JP) 2023-016261

(51) Int. Cl. B62D 25/20; B62D 25/02

(52) U.S. Cl. CPC B62D 25/2036; B62D 25/025

(57) ABSTRACT

A side sill structure includes a side sill main having an outside wall and an inside wall and an energy absorbing structure forming a plurality of hollow portions arranged in a vehicle length direction inside the side sill main body. The energy absorbing structure has a base component having a first vertical plate portion that extends in the vehicle length direction on an outer side in a vehicle width direction with respect to a plurality of through-holes arranged in the vehicle length direction and is bonded to an inner surface of the outside wall, a plurality of horizontal plate portions that extend from the first vertical plate portion between adjacent through-holes and a plurality of flange portions that are cut-folded upward from respective ones of the plurality of horizontal plate portions. The horizontal plate portions and the flange portions are arranged in the vehicle length direction.

### TECHNICAL FIELD

The present disclosure relates to a side sill structure.

### BACKGROUND ART

Patent Document 1 discloses a side sill as a part of a vehicle side structure. A plurality of hollow structures are built into a side sill main body and arranged in a vehicle length direction in order to protect an occupant or the like at the time of occurrence of a side collision. Each of the hollow structures includes a reinforcement member that extends in a vehicle width direction and is welded to the side sill main body.

### PRIOR ART DOCUMENT

### Patent Document

Patent Document 1: JP-A-2020-203599

### SUMMARY OF THE INVENTION

### Problems to be Solved by the Invention

A plurality of hollow structures are configured independently of each other. Therefore, the number of components of a side sill and the number of assembling steps increase, and the weight may increase.

In this respect, an object of the present disclosure is to provide a side sill structure that achieves weight reduction of a vehicle body by reducing the number of components or the number of assembling steps and is excellent in impact absorption performance at the time of occurrence of a side collision.

### Solutions to the Problems

An aspect of the present disclosure provides a side sill structure including: a side sill main body extending in a vehicle length direction; and an energy absorbing structure that forms a plurality of hollow portions which individually extend in a vehicle width direction inside the side sill main body and are arranged at intervals in the vehicle length direction. The side sill main body includes an outer wall on an outer side in the vehicle width direction, an inner wall on an inner side in the vehicle width direction, and an upper wall connecting upper ends of the outer wall and the inner wall to each other in the vehicle width direction. The energy absorbing structure includes a base component. The base component includes a plurality of through-holes arranged in the vehicle length direction, a first vertical plate portion that extends in the vehicle length direction on the outer side in the vehicle width direction with respect to the plurality of through-holes and is bonded to an inner surface of the outer wall, a plurality of horizontal plate portions that individually extend in the vehicle width direction from the first vertical plate portion and between two adjacent through-holes among the plurality of through-holes and that are arranged in the vehicle length direction, and a plurality of flange portions each of which is punched and bent upward from a corresponding one of the plurality of horizontal plate portions, the plurality of flange portions being arranged at intervals in the vehicle length direction.

According to the above-described configuration, the energy absorbing structure forming the plurality of hollow portions has the base component. The base component has the first vertical plate portion extending in the vehicle length direction, and the plurality of flange portions are provided integrally with the first vertical plate portion via the plurality of horizontal plate portions. Each of the flange portions extends upward when viewed from the horizontal plate portions and the first vertical plate portion, whereby each of the flange portions, each of the horizontal plate portions, and the upper wall demarcate each of the hollow portions extending in the vehicle width direction inside the side sill main body. Sets of the plurality of flange portions and the plurality of horizontal plate portions and the plurality of through-holes are alternately arranged in the vehicle length direction, and a plurality of tubular structures are arranged at intervals in the vehicle length direction.

When a side collision occurs, the impact is applied to the outer wall of the side sill main body. The outer wall is bonded to the first vertical plate portion extending in the vehicle length direction. Therefore, the impact is likely to be transmitted to the base component, and the energy absorbing structure can absorb the impact well. The energy absorbing structure mainly includes the single base component. As compared with a case where the hollow portions include individual independent components, it is possible to reduce the number of components and the number of assembling steps of the energy absorbing structure and the side sill structure. In addition, the through-holes are formed between the plurality of tubular structures. The number of components and the number of assembling steps can be reduced by using the base component elongated in the vehicle length direction, and the side sill structure becomes lighter even if the base component elongated in the vehicle length direction is used.

The base component may be formed from the same type of metal material as the side sill main body, and the first vertical plate portion may be welded to the outer wall.

According to the above-described configuration, since the base component can be bonded to the side sill main body by using a technique with high work efficiency such as resistance welding, the side sill structure can be easily manufactured.

A plate thickness direction of the first vertical plate portion may be oriented in the vehicle width direction, and the first vertical plate portion may overlap the inner surface of the outer wall.

According to the above-described configuration, the bonding strength of the first vertical plate portion to the side sill main body is improved, and the strength of the side sill structure is increased. Note that a case where “(two plate-shaped parts) overlap each other” means that the two parts are layered in a state in which plate thickness directions of the two parts are aligned, and includes both of a case where the two parts are in direct surface contact with each other and a case where another member (for example, a patch member or an adhesive) is interposed between the two parts.

The base component may further have a second vertical plate portion that extends in the vehicle length direction on the inner side in the vehicle width direction with respect to the plurality of through-holes, is continuous to the plurality of horizontal plate portions, and overlaps an inner surface of the inner wall.

According to the above-described configuration, the plurality of horizontal plate portions are supported by both the first vertical plate portion and the second vertical plate portion, rather than being cantilevered. The base component is stably attached to the side sill main body in a state of being sandwiched by the outer wall and the inner wall in the vehicle width direction. Therefore, the strength or the impact absorption performance of each tubular structure is improved.

At least one of the plurality of horizontal plate portions may have a bead portion that projects upward or downward and extends in the vehicle width direction.

According to the above-described configuration, the stiffness of the horizontal plate portions is improved.

Each of the flange portions may have, at an upper end portion thereof, a tab portion, and the tab portion may have an upper surface that overlaps an inner surface of the upper wall.

According to the above-described configuration, each of the flange portions is stably supported by the upper wall via the tab portion, and the impact absorption performance in the tubular structure is improved.

Each of the flange portions may have one or more folding portions between a lower end and an upper end of each of the flange portions.

According to the above-described configuration, each of the flange portions extends from the lower end to the upper end while changing a gradient at the folding portions. In other words, each of the flange portions has a wall part on a lower side of the folding portion and a wall part on an upper side of the folding portion, and an inclination with respect to the up-down direction varies depending on the wall parts. When a impact is applied to the outer wall, the impact is transmitted inward in the vehicle width direction via the plurality of wall parts. Therefore, the impact absorption performance of the energy absorbing structure is improved.

Each of the flange portions may include a front flange portion extending upward from a front edge portion of each of the horizontal plate portions, and a rear flange portion extending upward from a rear edge portion of each of the horizontal plate portions.

According to the above-described configuration, each of the tubular structures is demarcated by the horizontal plate portion, the upper wall, and a pair of flange portions in the vehicle length direction which vertically connect the horizontal plate portion and the upper wall. Each of the tubular structures forms a closed cross section when viewed in the vehicle width direction. This causes the strength or the impact absorption performance of the tubular structures to be improved.

The front flange portion and the rear flange portion may be inclined to be separated from each other in the vehicle length direction as the front and rear flange portions extend upward.

According to the above-described configuration, a cross-sectional area of each of the tubular structures is increased even if each of the horizontal plate portions is not large in the vehicle length direction. This causes the strength or the impact absorption performance of the tubular structures to be further improved.

Each of the front flange portion and the rear flange portion may have one folding portion between a lower end and an upper end of each of the front and rear flange portions, and each of the plurality of tubular structures may be demarcated by each of the horizontal plate portions, the front flange portion, the rear flange portion, and the upper wall, and has a hexagonal cross section when viewed in the vehicle width direction.

According to the above-described configuration, since each of the tubular structures has a hexagonal closed cross section, high strength or impact absorption performance can be obtained in each of the tubular structures.

The energy absorbing structure may further include an outer patch having an upper cover portion that covers an upper portion of each of the flange portions, and a side cover portion that extends downward from a side end edge of the upper cover portion and covers a side portion of each of the flange portions in the vehicle width direction. The side cover portion may be welded to the outer wall, and the upper cover portion may be welded to the upper wall.

According to the above-described configuration, the base component is bonded to the side sill main body in both the vehicle width direction and the up-down direction, and the bonding strength of the energy absorbing structure to the side sill main body is improved.

The energy absorbing structure may further have a reinforcement component bonded to each of the flange portions.

According to the above-described configuration, the impact absorption performance can be easily improved as necessary by the reinforcement component.

The reinforcement component may have an end portion on the outer side in the vehicle width direction at which a projecting portion is provided. A plate thickness direction of the first vertical plate portion and a plate thickness direction of the projecting portion may be oriented in the vehicle width direction. The first vertical plate portion and the tab portion may overlap the inner surface of the outer wall and may be bonded to the outer wall.

According to the above-described configuration, the bonding strength of the reinforcement component to the base component is improved, and the bonding strength of the base component to the side sill main body is improved. In particular, it is possible to prevent the energy absorbing structure from falling sideways at the time of a side collision, and impact absorption performance is improved. Note that the sideways falling refers to buckling caused by partially generating a large compressive force in the energy absorbing structure at the time of a collision, and a direction of the sideways fall varies depending on a shape of the energy absorbing structure, and may be the up-down direction or the vehicle length direction.

Each of the flange portions includes a front flange portion extending upward from a front edge portion of each of the horizontal plate portions, and a rear flange portion extending upward from a rear edge portion of each of the horizontal plate portions. The reinforcement component has a front wall portion that passes through one of the through-holes adjacent to a front side of the front flange portion, extends in an up-down direction, and is bonded to an outer surface of the front flange portion, a rear wall portion that passes through one of the through-holes adjacent to a rear side of the rear flange portion, extends in the up-down direction, and is bonded to an outer surface of the rear flange portion, and a web portion connecting lower ends of the front wall portion and the rear wall portion to each other in the vehicle length direction, below each of the horizontal plate portions.

According to the above-described configuration, a closed cross section demarcated by the reinforcement component below each of the flange portions is added to each of the tubular structures. This causes the strength or the impact absorption performance of the energy absorbing structures to be improved.

The web portion may have a raised bottom portion that projects upward and extends in the vehicle width direction, and the projecting portion may be welded to each of the horizontal plate portions.

According to the above-described configuration, the raised bottom portion is provided, thereby improving the stiffness of the reinforcement component. Since the reinforcement component is bonded to the base component in the up-down direction, the bonding strength of the reinforcement component to the base component is improved.

The energy absorbing structure may further have a plurality of tubular components that individually extend in the vehicle width direction and have a closed cross section when viewed in the vehicle width direction, and each of the plurality of tubular components is bonded to at least one of the horizontal plate portions or the flange portions.

According to the above-described configuration, a closed cross section demarcated by the tubular components is added to the tubular structure. This causes the strength or the impact absorption performance of the energy absorbing structures to be improved.

The base component may be formed from the same kind of metal material as the side sill main body. The tubular components may be formed from a kind of metal material different from materials of the side sill main body and the base component. The base component may be welded to the side sill main body, and the tubular components may be mechanically bonded to the base component.

According to the above-described configuration, since mechanical bonding is applied to the bonding of the tubular component and the base component to the side sill main body, it is easy to select, as a material of the tubular component, a metal material different from those of the side sill main body and the base component. Note that, as an example of the mechanical bonding, fastening using a bolt or a rivet or adhesion using an adhesive can be exemplified.

### Effects of the Invention

According to the present disclosure, it is possible to provide a side sill structure that is reduced in the number of components or the number of assembling steps and is excellent in impact absorption performance at the time of occurrence of a side collision.

### BRIEF DESCRIPTION OF THE DRAWINGS

FIG. 1 is a perspective view showing a vehicle body of a vehicle to which a side sill according to a first embodiment is applied.

FIG. 2 is a cross-sectional view showing the side sill according to the first embodiment.

FIG. 3A is a longitudinal-sectional view taken along line III-III in FIG. 2.

FIG. 3B is a partially enlarged view of FIG. 3A.

FIG. 4 is a plan view of a blank plate of a base component according to the first embodiment.

FIG. 5 is a perspective view of an energy absorbing structure according to the first embodiment.

FIG. 6 is a cross-sectional view showing a side sill structure according to a second embodiment.

FIG. 7A is a cross-sectional view taken along line VII-VII in FIG. 6.

FIG. 7B is a partially enlarged view of FIG. 7A.

FIG. 8 is a perspective view of an energy absorbing structure according to the second embodiment.

FIG. 9 is a cross-sectional view showing a side sill according to a third embodiment.

FIG. 10A is a cross-sectional view taken along line X-X in FIG. 9.

FIG. 10B is a partially enlarged view of FIG. 10A.

FIG. 11 is a perspective view showing an energy absorbing structure according to a third embodiment.

FIG. 12 is a cross-sectional view showing a side sill according to a fourth embodiment.

FIG. 13A is a cross-sectional view taken along line XIII-XIII of FIG. 12.

FIG. 13B is a partially enlarged view of FIG. 13A.

FIG. 14 is a perspective view showing an energy absorbing structure according to the fourth embodiment.

FIG. 15 is a cross-sectional view showing a side sill according to a fifth embodiment.

FIG. 16A is a cross-sectional view taken along line XVI-XVI in FIG. 15.

FIG. 16B is a partially enlarged view of FIG. 16A.

FIG. 16C is a partially enlarged view of FIG. 16B.

FIG. 17 is a perspective view showing an energy absorbing structure according to the fifth embodiment.

FIG. 18 is a cross-sectional view showing a side sill according to a sixth embodiment.

FIG. 19A is a cross-sectional view taken along line XIX-XIX in FIG. 18.

FIG. 19B is a partially enlarged view of FIG. 19A.

FIG. 19C is a partially enlarged view of FIG. 19B.

FIG. 20 is a perspective view of an energy absorbing structure according to the sixth embodiment.

### DETAILED DESCRIPTION

Hereinafter, embodiments will be described with reference to the drawings.

Note that the same or corresponding elements are denoted by the same reference numerals throughout the drawings, and redundant detailed description will be omitted. A vehicle length direction corresponds to a front-rear direction, and a vehicle width direction corresponds to a left-right direction. An outer side in the vehicle width direction is a side away from a vehicle width centerline of a vehicle, and an inner side in the vehicle width direction is a side close to the vehicle width centerline of the vehicle. Cross marks in the drawings indicate bonding point by spot welding.

### First Embodiment

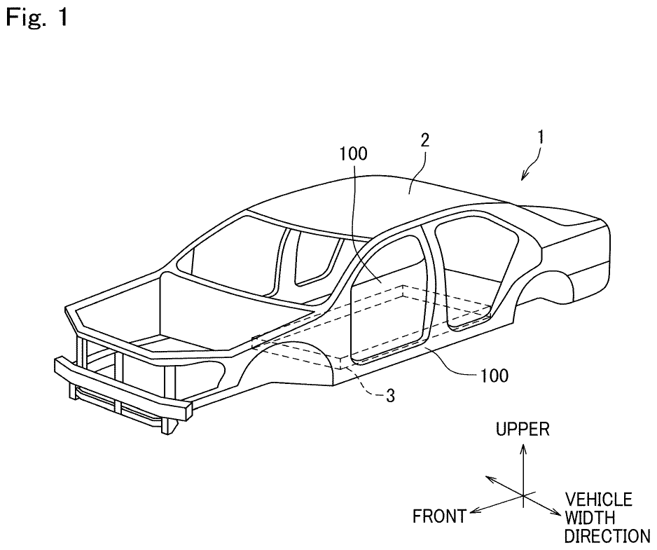

FIG. 1 illustrates a vehicle body 2 of a vehicle 1 to which a side sill 100 according to an embodiment is applied. The vehicle 1 is an electric vehicle or a hybrid vehicle including an electric motor (not illustrated) as a power source for traveling and a battery 3 as an electrical power source of the power source. The vehicle body 2 includes a pair of side sills 100 extending in the vehicle length direction at lower portions on both sides in the vehicle width direction. The pair of side sills 100 are bilaterally symmetrical. The battery 3 is housed in a short-height rectangular parallelepiped housing, is disposed between the pair of side sills 100, and is supported by the pair of side sills 100. In a case where collision energy due to occurrence of a side collision is applied to the vehicle 1, the side sills 100 absorb this impact, thereby protecting the battery 3.

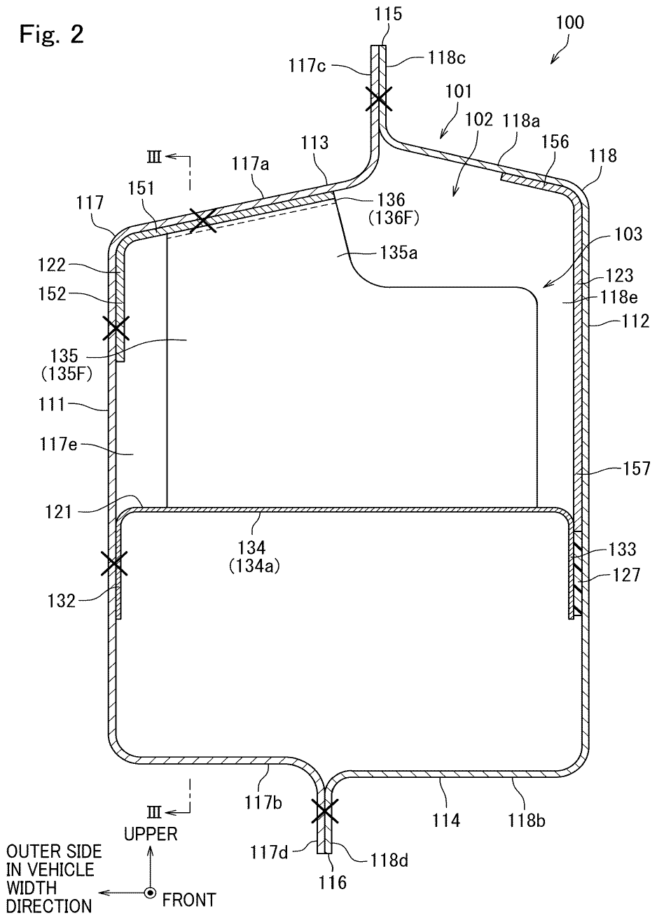

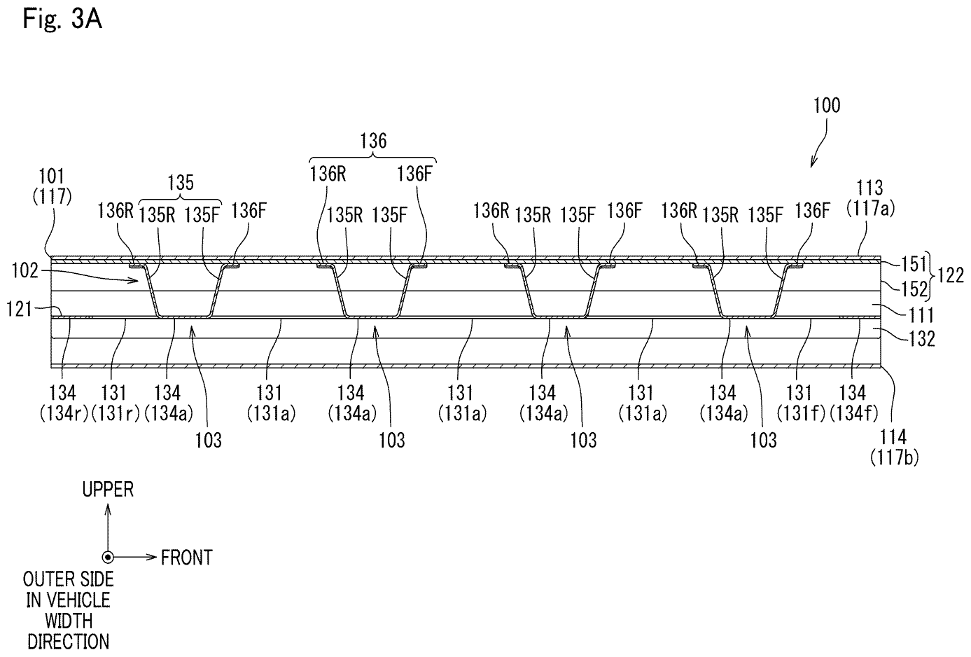

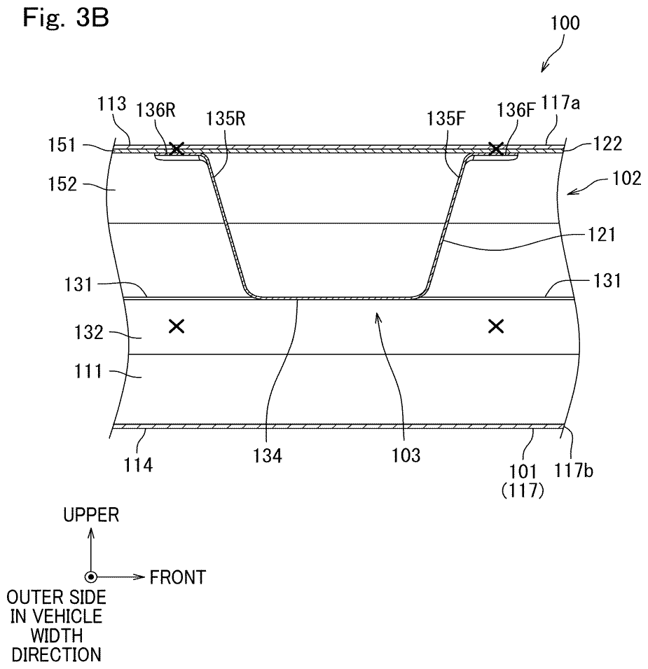

With reference to FIGS. 2 and 3A, the side sill 100 includes a side sill main body 101 and an energy absorbing structure 102. The side sill main body 101 extends in the vehicle length direction. The energy absorbing structure 102 is provided inside the side sill main body 101. The energy absorbing structure 102 forms a plurality of hollow portions 103 arranged at intervals in the vehicle length direction. Each hollow portion 103 extends in the vehicle width direction inside the side sill main body 101.

With reference to FIG. 2, the side sill main body 101 has an outer wall 111 extending in an up-down direction on the outer side in the vehicle width direction, an inner wall 112 extending in the up-down direction on the inner side in the vehicle width direction, an upper wall 113 connecting upper ends of the outer wall 111 and the inner wall 112 to each other in the vehicle width direction, and a lower wall 114 connecting lower ends of the outer wall 111 and the inner wall 112 to each other in the vehicle width direction. The side sill main body 101 has a closed cross section having a substantially oblong shape when viewed in the vehicle length direction, and the four walls demarcate an internal space of the side sill main body 101. The side sill main body 101 further has an upper flange 115 extending upward from a central portion of the upper wall 113 in the vehicle width direction and a lower flange 116 extending downward from a central portion of the lower wall 114 in the vehicle width direction.

The side sill main body 101 mainly includes two components of an outer side sill 117 and an inner side sill 118. Both the outer side sill 117 and the inner side sill 118 are press-formed from an iron-based metal material such as steel and have a hat-shaped cross section.

The outer side sill 117 has a web portion as the outer wall 111, an outer upper wall 117a and an outer lower wall 117b extending inward in the vehicle width direction from both upper and lower ends of the web portion, respectively, an outer upper flange 117c extending upward from an inner end of the outer upper wall 117a, and an outer lower flange 117d extending downward from an inner end of the outer lower wall 117b. The outer side sill 117 forms a space 117e demarcated by the outer wall 111, the outer upper wall 117a, and the outer lower wall 117b.

Similarly, the inner side sill 118 has a web portion as the inner wall 112, an inner upper wall 118a and an inner lower wall 118b extending outward in the vehicle width direction from both upper and lower ends of the web portion, respectively, an inner upper flange 118c extending upward from an outer end of the inner upper wall & 118a, and an inner lower flange 118d extending downward from an outer end of the inner lower wall 118b. The inner side sill 118 forms a space 118e demarcated by the inner wall 112, the inner upper wall 118a, and the inner lower wall 118b.

The inner and outer upper flanges 117c and 118c overlap each other in the vehicle width direction and are spot-welded together, and the inner and outer lower flanges 117d and 118d overlap each other in the vehicle width direction and are spot-welded together. Note that, regarding both upper and lower spot welding, a plurality of bonding points are set at intervals in the vehicle length direction. The inner and outer upper walls 117a and 118a constitute the upper wall 113 of the entire side sill main body 101, and the inner and outer lower walls 117b and 118b constitute the lower wall 114 of the entire side sill main body 101. The inner and outer upper flanges 117c and 118c constitute the upper flange 115 of the entire side sill main body 101, and the inner and outer lower flanges 117d and 118d constitute the lower flange 116 of the entire side sill main body 101. The inner and outer spaces 117e and 118e are continuous in the vehicle width direction, thereby providing the above-described internal space in the side sill main body 101.

With reference to FIG. 2, the energy absorbing structure 102 has a base component 121, an outer patch 122, and an inner patch 123.

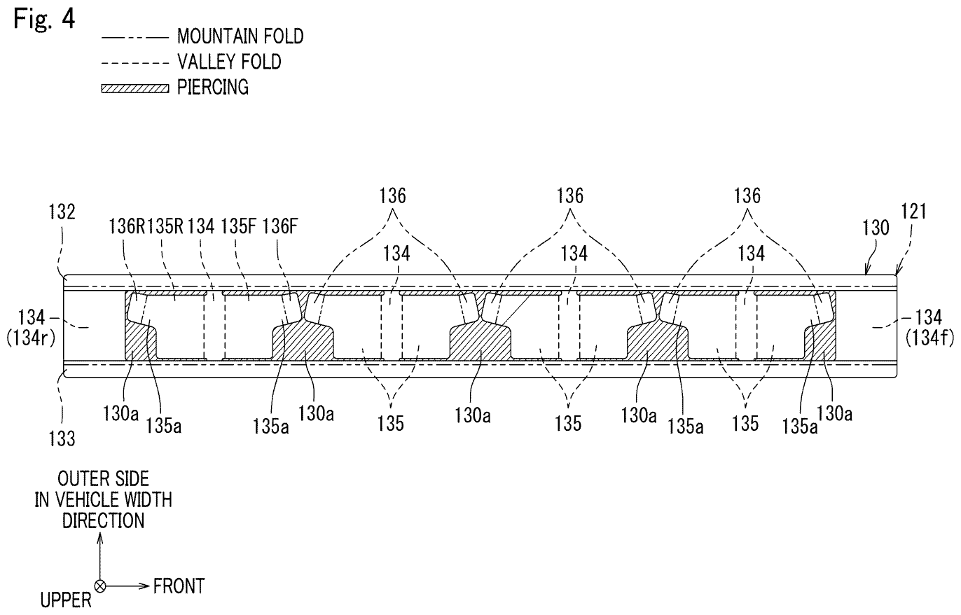

The base component 121 is made of a single blank plate 130 (see FIG. 4) and extends in the vehicle length direction. The base component 121 or the blank plate 130 thereof is press-formed from the same kind of metal material (that is, an iron-based metal material) as that of the side sill main body 101, and has a uniform plate thickness over the entire length thereof. The outer patch 122 and the inner patch 123 are interposed between an inner surface of the side sill main body 101 and the base component 121. The outer patch 122 and the inner patch 123 have substantially the same length as the side sill main body 101 in the vehicle length direction.

With reference to FIGS. 2, 3A, and 3B, the base component 121 according to the present embodiment has a plurality of through-holes 131, a first vertical plate portion 132, a second vertical plate portion 133, a plurality of horizontal plate portions 134, a plurality of flange portions 135, and a plurality of tab portions 136.

The plurality of through-holes 131 are arranged in the vehicle length direction. The first vertical plate portion 132 extends in the vehicle length direction with respect to the through-hole 131, on the outer side in the vehicle width direction. The second vertical plate portion 133 extends in the vehicle length direction with respect to the through-hole 131, on the inner side in the vehicle width direction. The plurality of horizontal plate portions 134 are arranged in the vehicle length direction. Each of the horizontal plate portions 134 extends in the vehicle width direction from the first vertical plate portion 132 and is continuous with the second vertical plate portion 133. Each of the horizontal plate portions 134 includes one or more intermediate horizontal plate portions 134a (the number of which is smaller than the number of the through-holes 131 by one), a front end horizontal plate portion 134b, and a rear end horizontal plate portion 134c. Each intermediate horizontal plate portion 134a is disposed between two adjacent through-holes 131 of the plurality of through-holes. The front end horizontal plate portion 134b is disposed in front of the through-hole 131f at the front end, and connects front ends of the vertical plate portions 132 and 133 to each other. The rear end horizontal plate portion 134c is disposed behind the through-hole 131r at the rear end, and connects rear ends of the vertical plate portions 132 and 133 to each other. In this manner, the base component 121 is formed in a rectangular frame shape and a ladder shape as a whole.

Plate thickness directions of the first vertical plate portion 132 and the second vertical plate portion 133 are oriented in the vehicle width direction. In other words, the first vertical plate portion 132 and the second vertical plate portion 133 are parallel to the outer wall 111 and the inner wall 112. A plate thickness direction of the horizontal plate portion 134 is oriented in the up-down direction. The first vertical plate portion 132 and the second vertical plate portion 133 extend in the up-down direction (downward, as an example in the present embodiment) from respective end portions of the horizontal plate portion 134.

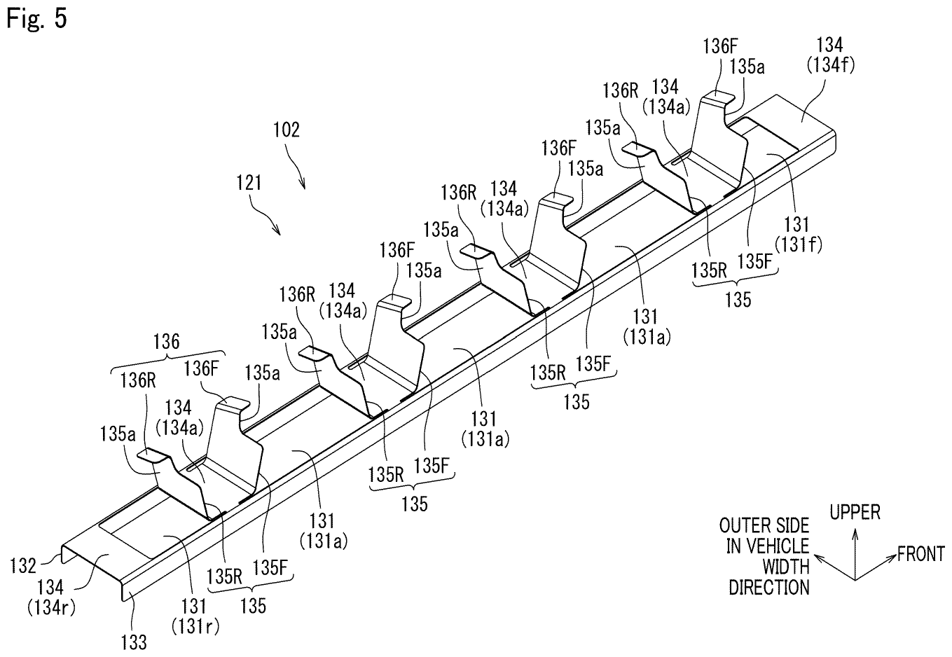

A method of press-forming the base component 121 having such a structure will be described with reference to FIGS. 4 and 5. FIG. 4 is a plan view of the blank plate 130. In FIG. 4, hatching represents a region removed from the blank plate 130 by performing punching (piercing), and a two-dot chain line and a broken line represent a folding line in bending after the piercing. The blank plate 130 is a material of the base component 121 and is sheet metal having a uniform plate thickness. The blank plate 130 has an oblong shape in plan view. A longitudinal direction of the blank plate 130 is oriented in the vehicle length direction in a state in which the base component 121 becomes a part of the side sill 100 and is assembled to the vehicle body 2.

First, the blank plate 130 is subjected to punching (piercing) to form a plurality of initial through-holes 130a. The number of initial through-holes 130a to be formed is the same as the number of the through-holes 131 in a completed state, and the initial through-holes 130a are formed at intervals in the longitudinal direction (corresponding to the vehicle length direction) of the blank plate 130.

In the punching, a die (not illustrated) is pressed against the blank plate 130 from above. This allows the initial through-hole 130a to be formed, and allows an outline of the die to be transferred as an edge of the initial through-hole 130a. In this case, a series of processes of intermittently conveying the blank plates 130 along the longitudinal direction thereof and lifting and lowering the die while the blank plate 130 is stopped is repeated a designated number of times, thereby forming a designated number of (for example, five) initial through-holes 130a. This enables a size of a punching machine to be reduced, and enables a driving force which needs to be applied to the die to be reduced as compared with a case where the plurality of initial through-holes 130a are simultaneously formed by a single lifting-lowering operation.

Note that the initial through-holes 130a at a rear end, at a front end, and in the middle have different shapes from each other in plan view. An intermediate initial through-hole 130a has a shape in which a shape at the rear end and a shape at the front end are aligned in the vehicle length direction. Hence, two dies of a die suitable for at least the shape at the rear end and a die suitable for the shape at the front end are prepared, and the at least two dies are configured to be movable up and down independently of each other.

Next, the flange portions 135 are punched and bent upward from respective ones of the horizontal plate portions 134, such that one horizontal plate portion 134 remains between two adjacent initial through-holes 130a. This allows the plurality of flange portions 135 to be provided in one-to-one correspondence with the plurality of horizontal plate portions 134 and be arranged in the vehicle length direction.

In the present embodiment, the horizontal plate portion 134 is punched and bent on both front and rear sides thereof. Each of the flange portions 135 includes a front flange portion 135F that is punched and bent upward and extends from a front edge portion of the corresponding horizontal plate portion 134 and a rear flange portion 135R that is punched and bent upward and extends from a rear edge portion of the corresponding horizontal plate portion 134. The front edge portion and the rear edge portion of the horizontal plate portion 134 extend parallel to the vehicle width direction without being inclined in the vehicle length direction.

In this manner, cut-folding is performed to form the flange portion 135, thereby widening the initial through-hole 130a in the vehicle length direction. This allows the base component 121 in an application state to have the through-hole 131 larger than that at the time of punching.

The front flange portion 135F and the rear flange portion 135R extend upward from the horizontal plate portion 134 while being inclined in the vehicle length direction with respect to the up-down direction. The front flange portion 135F and the rear flange portion 135R are symmetrical in the front-rear direction when viewed in the vehicle width direction. The front flange portion 135F and the rear flange portion 135R are inclined to be separated from each other in the vehicle length direction as the front and rear flange portions extend upward. The front flange portion 135F is inclined frontward, and the rear flange portion 135R is inclined rearward.

The front flange portion 135F has, at a part thereof on the outer side in the vehicle width direction, a projecting portion 135a projecting upward from a part of the front flange portion on the inner side in the vehicle width direction. The same applies to the rear flange portion 135R. Next, a distal end portion of the projecting portion 135a is subjected to bending, and the tab portion 136 is provided at an upper end portion of the flange portion 135. In the present embodiment, the tab portion 136 includes a front tab portion 136F provided at an upper end portion of the front flange portion 135F and a rear tab portion 136R provided at an upper end portion of the rear flange portion 135R.

An upper surface of the tab portion 136 is disposed parallel to an inner surface of the upper wall 113 of the side sill main body 101 (see FIG. 2). Here, the outer upper wall 117a of the upper wall 113 and an inner surface thereof are inclined downward as the outer upper wall and the inner surface extend outward in the vehicle width direction. As described above, the projecting portion 135a is formed at a part relatively on the outer side in the vehicle width direction. In association with this, the tab portion 136 is also provided at a portion of the base component 121 on the outer side in the vehicle width direction. As will be described below, the tab portions 136 are supported by the inner surface of the outer upper wall 117a of the upper wall 113.

The front flange portion 135F is punched and bent upward from the front edge portion of the horizontal plate portion 134 extending in the vehicle width direction without being inclined in the vehicle length direction, while the tab portion 136 is parallel to the inner surface of the outer upper wall 117a that is inclined downward. Therefore, in plan view of the blank plate 130, a folding line for forming the tab portion 136 is inclined outward in the vehicle length direction (a front side for front flange portion 135F and a rear side for rear flange portion 135R) from the outer side toward the inner side in the vehicle width direction. Therefore, if a part which is to be formed as the tab portion 136 extends all along the base component 121 in the vehicle width direction, it is necessary to widen the initial through-hole 130a in the vehicle length direction accordingly, and the number of the horizontal plate portions 134 and the flange portions 135 that can be formed is reduced. Hence, the projecting portions 135a and the tab portions 136 are formed exclusively in a part on the outer side in the vehicle width direction. This enables a height of the flange portion 135 to be increased, the tab portion 136 to be disposed parallel to the inner surface of the inclined outer upper wall 117a, and the number of the horizontal plate portions 134 and the flange portions 135 which can be formed to be secured.

Both the outer patch 122 and the inner patch 123 are press-formed from the same kind of metal material as that of the side sill main body 101 and the base component 121. The outer patch 122 and the inner patch 123 have an L shape when viewed in the vehicle length direction, and have a sheet shape with a small plate thickness.

The outer patch 122 has an upper cover portion 151 that covers an upper portion of the flange portion 135, and a side cover portion 152 that extends downward from an outer end edge of the upper cover portion 151 in the vehicle width direction and covers a side portion of the flange portion 135. The upper cover portion 151 is parallel to the inner surface of the outer upper wall 117a and the upper surface of the tab portion 136 and is interposed between the outer upper wall 117a and the flange portion 135. The side cover portion 152 is parallel to the inner surface of the outer wall 111 (and the side surface of the first vertical plate portion 132), and overlaps the inner surface of the outer wall 111 above the first vertical plate portion 132. The inner patch 123 has an upper cover portion 156 bonded to the inner surface of the inner upper wall 118a, and a side cover portion 157 that extends downward from an inner end edge of the upper cover portion 156 in the vehicle width direction and is bonded to the inner surface of the inner wall 112.

When the side sill 100 is assembled, first, as described above, the single blank plate 130 is subjected to required press working, thereby preparing the base component 121 as a single piece. The outer patch 122 is bonded to the base component 121. The outer patch 122 is provided on the base component 121 in a posture in which the upper cover portion 151 covers the base component 121 from above and the side cover portion 152 covers the base component 121 from the outer side in the vehicle width direction. Each tab portion 136 is spot-welded to the upper cover portion 151 in a state of overlapping the upper cover portion 151. A plurality of bonding points is set at intervals in the vehicle length direction.

An assembly including the base component 121 and the outer patch 122 is accommodated in a space 117e of the outer side sill 117. The first vertical plate portion 132 and the side cover portion 152 abut against the inner surface of the outer wall 111, and the tab portion 136 and the upper cover portion 151 on the upper side thereof abut against the inner surface of the outer upper wall 117a. In this posture, the outer side sill 117 is bonded to the base component 121 and the outer patch 122. The spot welding is also applied to this bonding. This results in a state in which the flange portion 135 is supported by the inner surface of the outer upper wall 117a.

The outer wall 111 is spot-welded to each of the side cover portion 152 and the first vertical plate portion 132, and the outer upper wall 117a is spot-welded to the upper cover portion 151 and the tab portion 136. In both the cases of spot welding, a plurality of bonding points are set at intervals in the vehicle length direction.

Next, the inner patch 123 is bonded to the inner side sill 118, and the inner side sill 118 is bonded to the outer side sill 117. In this case, a part of the base component 121 on the inner side in the vehicle width direction projects inward in the vehicle width direction with respect to the outer upper flange 117c and the outer lower flange 117d of the outer side sill 117. This projecting part is received in the space 118e of the inner side sill 118. The second vertical plate portion 133 abut against the inner surface of the inner wall 112, the inner upper flange 118c overlaps the outer upper flange 117c, and the inner lower flange 118d overlaps the outer lower flange 117d.

Next, the second vertical plate portion 133 is bonded to the inner wall 112. This bonding does not necessarily have to be metallurgical bonding, and an adhesive 127 may be used as illustrated in the drawings. The upper flange portion 117c and the inner upper flange 118c are welded, and the lower flanges 117d and 118d are welded to each other. Thus, the side sill 100 is completed.

The side sill 100 includes the side sill main body 101 extending in the vehicle length direction, and the energy absorbing structure 102 that extends in the vehicle width direction inside the side sill main body 101 and forms the plurality of hollow portions 103 arranged in the vehicle length direction. The side sill main body 101 has the outer wall 111 on the outer side in the vehicle width direction, the inner wall 112 on the inner side in the vehicle width direction, and the upper wall 113 connecting the upper ends of the outer wall 111 and the inner wall 112 to each other in the vehicle width direction. The energy absorbing structure 102 has the base component 121 formed from the single blank plate 130. The base component 121 has the plurality of through-holes 131 arranged in the vehicle length direction, the first vertical plate portion 132 that extends in the vehicle length direction on the outer side in the vehicle width direction with respect to the plurality of through-holes 131 and is bonded to the inner surface of the outer wall 111, the plurality of horizontal plate portions 134 that individually extend in the vehicle width direction from the first vertical plate portion 132 and between two adjacent through-holes 131 among the plurality of through-holes and that are arranged in the vehicle length direction, and the plurality of flange portions 135 that are punched and bent upward from respective ones of the plurality of horizontal plate portions 134 are supported by the inner surface of the upper wall 113, and are arranged in the vehicle length direction.

As described above, the energy absorbing structure 102 forming the plurality of hollow portions 103 has the base component 121 formed from the single blank plate 130. The base component 121 has the first vertical plate portion 132 that is bonded to the outer wall 111 of the side sill main body 101 and extends in the vehicle length direction. The plurality of flange portions 135 are provided to be continuous with the first vertical plate portion 132 via the plurality of horizontal plate portions 134. Each flange portion 135 extends upward when viewed from the horizontal plate portion 134 and the first vertical plate portion 132 and is supported by the inner surface of the upper wall 113 of the side sill main body 101. In this manner, the flange portion 135, the horizontal plate portion 134, and the upper wall 113 demarcate the hollow portion 103 extending in the vehicle width direction inside the side sill main body 101. Sets of the plurality of flange portions 135 and the plurality of horizontal plate portions 134 and the plurality of through-holes 131 are alternately arranged in the vehicle length direction, thus resulting in arrangement of the plurality of hollow portions 103 at intervals in the vehicle length direction.

In this manner, in a case where the impact is applied to the outer surface of the outer wall 111 of the side sill main body 101 due to the occurrence of a side collision, the impact is well absorbed by the energy absorbing structure 102. Since the outer wall 111 to which the impact is applied is bonded to the first vertical plate portion 132, the impact is likely to be transmitted to the base component 121 and a structure constituting the hollow portions 103, and the impact is likely to be absorbed by the structure. The energy absorbing structure 102 mainly includes the single base component 121. The number of components and the number of assembling steps can be reduced as compared with the case where the hollow portions 103 are configured independently of each other. The through-holes 131 are formed between the plurality of hollow portions 103. An increase in weight of the energy absorbing structure 102 and the side sill structure can be curbed while reduction in the number of components by using the base component 121 extending in the vehicle length direction is achieved.

The base component 121 is press-formed from the same kind of metal material as the side sill main body 101, particularly, an iron-based metal material. In this manner, since the base component 121 can be bonded to the side sill main body 101 by using a technique with high work efficiency such as resistance welding. Hence, the side sill 100 can be easily manufactured.

The base component 121 further has the second vertical plate portion 133. The second vertical plate portion 133 extends in the vehicle length direction on the inner side in the vehicle width direction with respect to the plurality of through-holes 131, is continuous with the plurality of horizontal plate portions 134, and is supported by the inner surface of the inner wall 112. This allows the plurality of horizontal plate portions 134 to be supported by both the first vertical plate portion 132 and the second vertical plate portion 133, rather than being cantilevered, and allows stiffness of the base component 121 to be improved. In addition, the base component 121 is stably supported by the side sill main body 101 in a state of being sandwiched by the outer wall 111 and the inner wall 112 in the vehicle width direction.

The plate thickness direction of the first vertical plate portion 132 is oriented in the vehicle width direction, and the first vertical plate portion 132 is parallel to the inner surface of the outer wall 111. Therefore, the bonding strength of the first vertical plate portion 132 to the side sill main body 101 is improved. The plate thickness direction of the second vertical plate portion 133 is oriented in the vehicle width direction, and the second vertical plate portion 133 is parallel to the inner surface of the inner wall 112. Therefore, the bonding strength of the base component 121 to the side sill main body 101 is improved.

Each of the flange portions 135 has, at the upper end portion thereof, the tab portion 136, and the tab portion 136 has the upper surface that is disposed parallel to the inner surface of the upper wall 113 and is supported by the inner surface. This allows the flange portion 135 to be stably supported by the upper wall 113 via the tab portion 136.

Each of the flange portions 135 includes the front flange portion 135F extending upward from the front edge portion of the corresponding horizontal plate portion 134, and the rear flange portion 135R extending upward from the rear edge portion of the corresponding horizontal plate portion 134. Each of the tubular structures is demarcated by the horizontal plate portion 134, the upper wall 113, and the pair of flange portions 135F and 135R which vertically connect the horizontal plate portion 134 and the upper wall 113. Since each of the tubular structures forms a closed cross section when viewed from in the vehicle width direction, high impact absorption performance is obtained in each of the tubular structures. Note that, in this configuration, the tab portion 136 includes the front tab portion 136F provided at the upper end portion of the front flange portion 135F and a rear tab portion 136R provided at the upper end portion of the rear flange portion 135R. Therefore, both of the pair of flange portions 135F and 135R are stably supported by the upper wall 113.

The front flange portion 135F and the rear flange portion 135R are inclined to be separated from each other in the vehicle length direction as the front and rear flange portions extend upward. Cross-sectional areas of the hollow portion 103 and a structure constituting the hollow portion are increased even if the horizontal plate portion 134 is not large in the vehicle length direction. Therefore, high strength or high impact absorption performance can be obtained in each structure.

The energy absorbing structure 102 further includes the outer patch 122 having the upper cover portion 151 that covers the upper portion of each of the flange portions 135, and the side cover portion 152 that extends downward from the side end edge of the upper cover portion 151 and covers the side portion of each of the flange portions 135 in the vehicle width direction. The side cover portion 152 is welded to the outer wall 111, and the upper cover portion 151 is welded to the upper wall 113. This causes the bonding strength of the first vertical plate portion 132 to the outer wall 111 to be improved, and allows the flange portion 135 to be bonded to the upper wall 113 in the up-down direction. The base component 121 is bonded to the side sill main body 101 in both the vehicle width direction and the up-down direction, thus improving the bonding strength of the energy absorbing structure 102 to the side sill main body 101.

The hollow portions 103 are arranged at intervals. Therefore, the strength is prevented from increasing excessively, and the weight of the side sill 100 is reduced.

The pair of flange portions 135F and 135R are formed by being punched and bent, and demarcate each hollow portion 103. Therefore, a large through-hole 131 is formed between the two adjacent hollow portions 103. The through-hole 131 is larger than at least the initial through-hole 130a by surface areas of the flange portion 135 and the tab portion 136. Therefore, when the plurality of tubular structures are provided using the base component 121 elongated in the vehicle length direction, an increase in weight of the base component 121 can be curbed.

### Second Embodiment

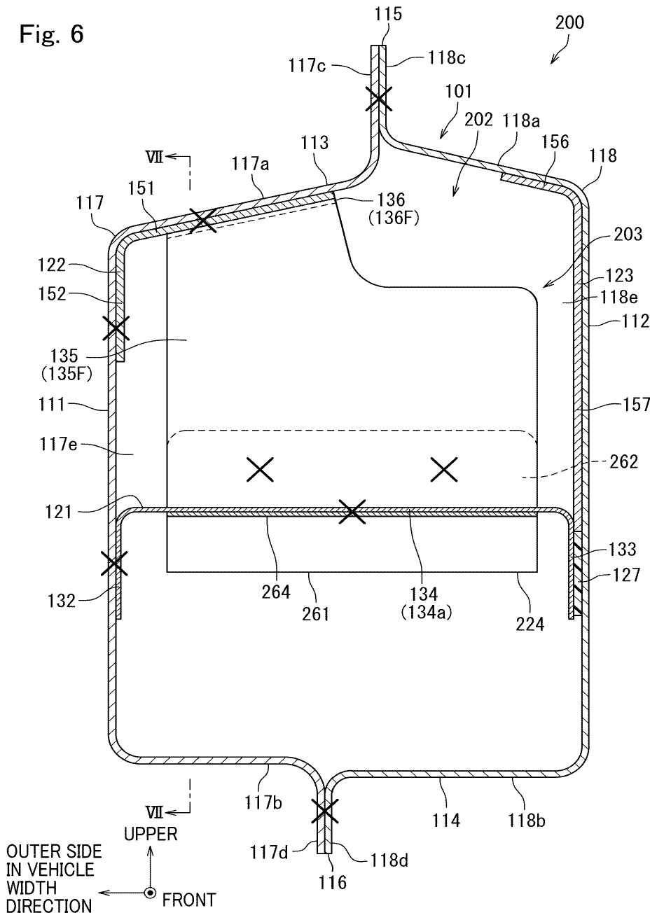

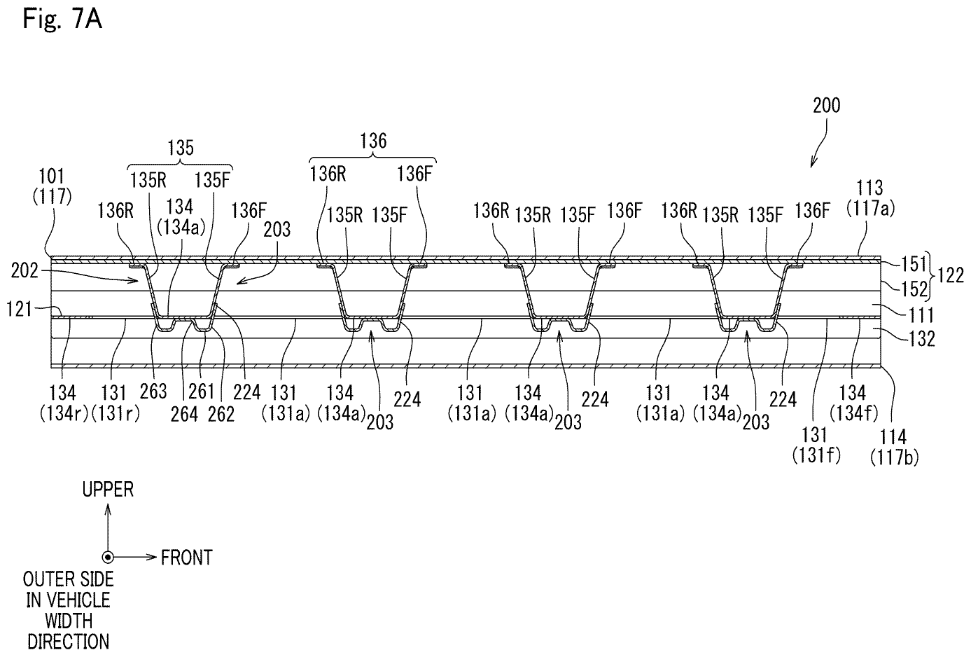

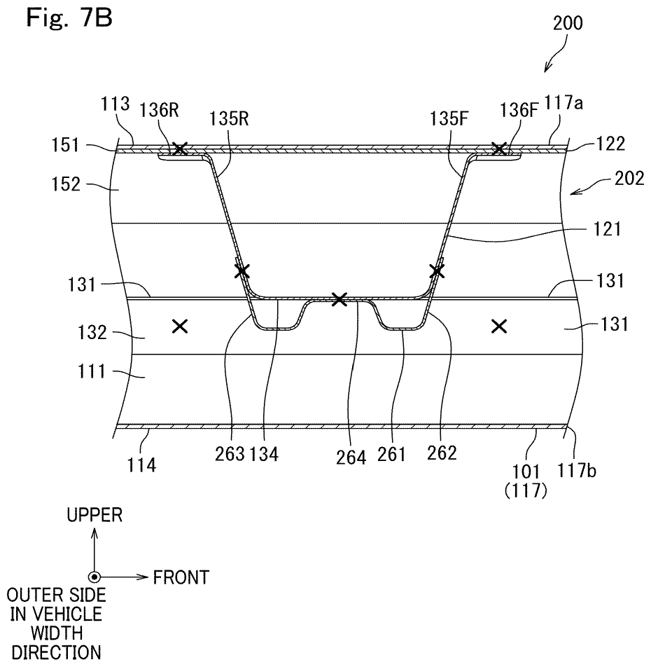

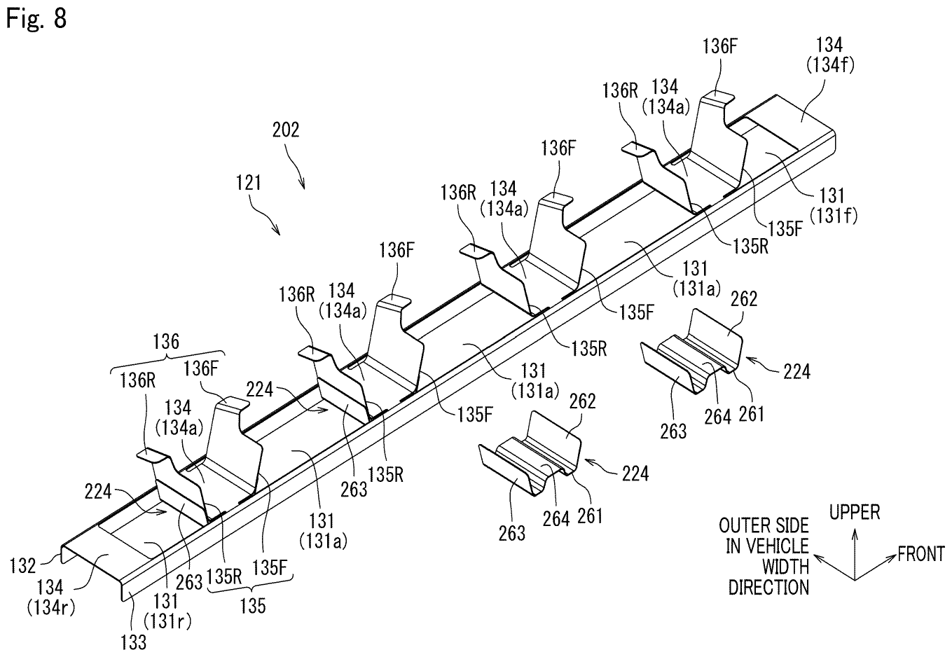

Next, a side sill 200 according to a second embodiment will be described with reference to FIGS. 6 to 8, focusing on differences from the above-described embodiment. The side sill main body 101 and the base component 121 are similar to those of the first embodiment. The present embodiment differs from the first embodiment in that an energy absorbing structure 202 further includes a plurality of reinforcement components 224 bonded to respective ones of the plurality of flange portions 135.

Each of the reinforcement components 224 has a hat-shaped cross section when viewed in the vehicle width direction. The reinforcement component 224 is press-formed from the same type of metal material (for example, an iron-based metal material) as the base component 121. The reinforcement component 224 has a web portion 261, a front wall portion 262, and a rear wall portion 263. The front wall portion 262 is bonded to an outer surface (front surface) of the front flange portion 135F. The rear wall portion 263 is bonded to an outer surface (rear surface) of the rear flange portion 135R. In both the cases of bonding, the spot welding is used, and one or more (for example, two) bonding points are set at intervals in the vehicle width direction.

The front wall portion 262 passes through the through-hole 131 adjacent to the front side of the front flange portion 135F and extends in the up-down direction. The rear wall portion 263 passes through the through-hole 131 adjacent to the rear of the rear flange portion 135R and extends in the up-down direction. Lower ends of the front wall portion 262 and the rear wall portion 263 are both positioned below the horizontal plate portion 134. The web portion 261 connects the lower ends of the front wall portion 262 and the rear wall portion 263 to each other in the vehicle length direction below the horizontal plate portion 134.

The web portion 261 has, at a central portion thereof in the vehicle length direction, a raised bottom portion 264 that projects upward with respect to the web portion 261 (in particular, an end portion thereof connected to the front wall portion 262 and the rear wall portion 263) and extends in the vehicle width direction. An upper surface of the raised bottom portion 264 is brought into surface contact with the lower surface of the horizontal plate portion 134. The raised bottom portion 264 may be welded to the horizontal plate portion 134. In the case of welding, spot welding can be suitably applied, and one or more bonding points (for example, one bonding point) is provided along a center of the horizontal plate portion 134 in the vehicle length direction.

The energy absorbing structure 102 further has the reinforcement component 224 bonded to each of the flange portions 135. The reinforcement component 224 is further provided, thereby causing a closed cross section demarcated by the reinforcement component 224 below the flange portion 135 to be added to the hollow portion 203. Therefore, the impact absorption performance of the energy absorbing structure 202 is improved. Since the raised bottom portion 264 is provided in the web portion 261, the stiffness of the reinforcement component 224 is improved. The raised bottom portion 264 is welded to the horizontal plate portion 134, thereby allowing the reinforcement component 224 to be bonded to the base component 121 not only in the vehicle length direction but also in the up-down direction. The bonding strength of the reinforcement component 224 to the base component 121 is improved, and high impact absorption performance is obtained in the tubular structure.

### Third Embodiment

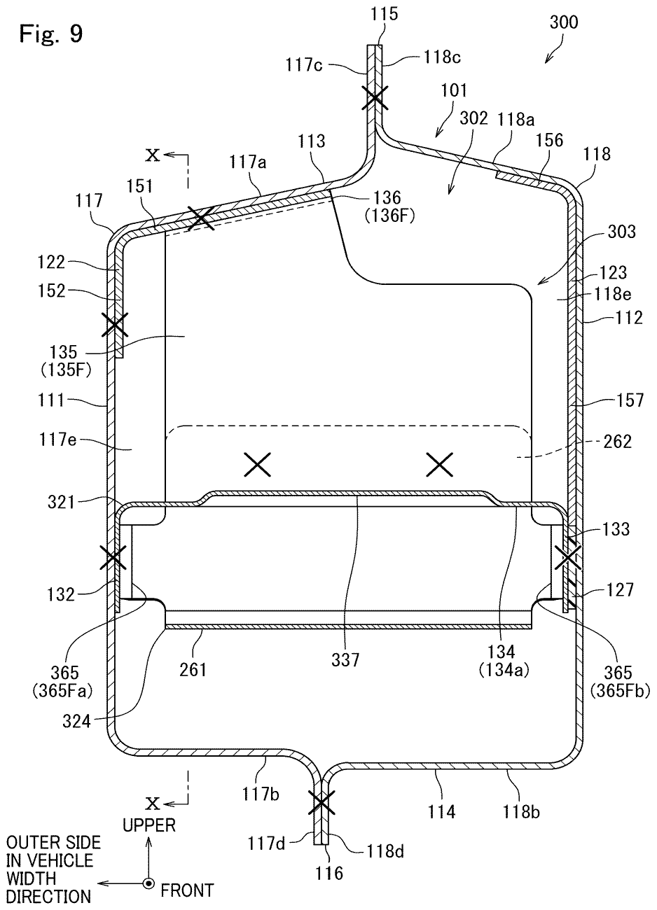

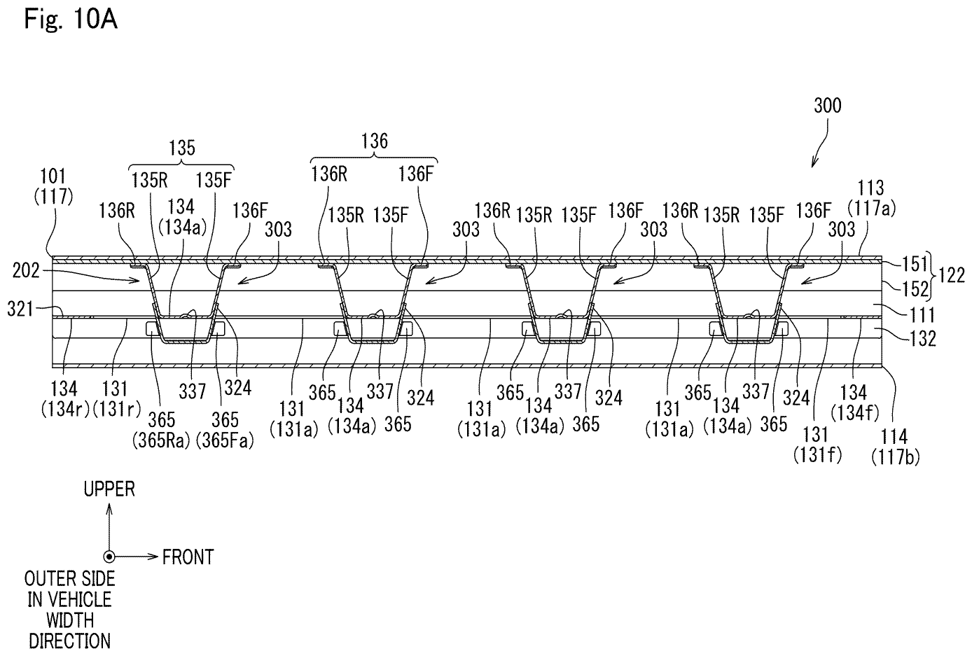

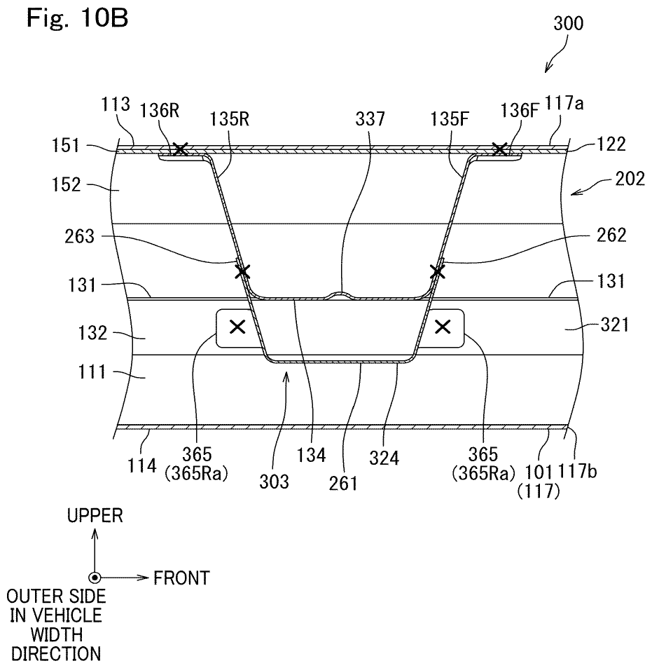

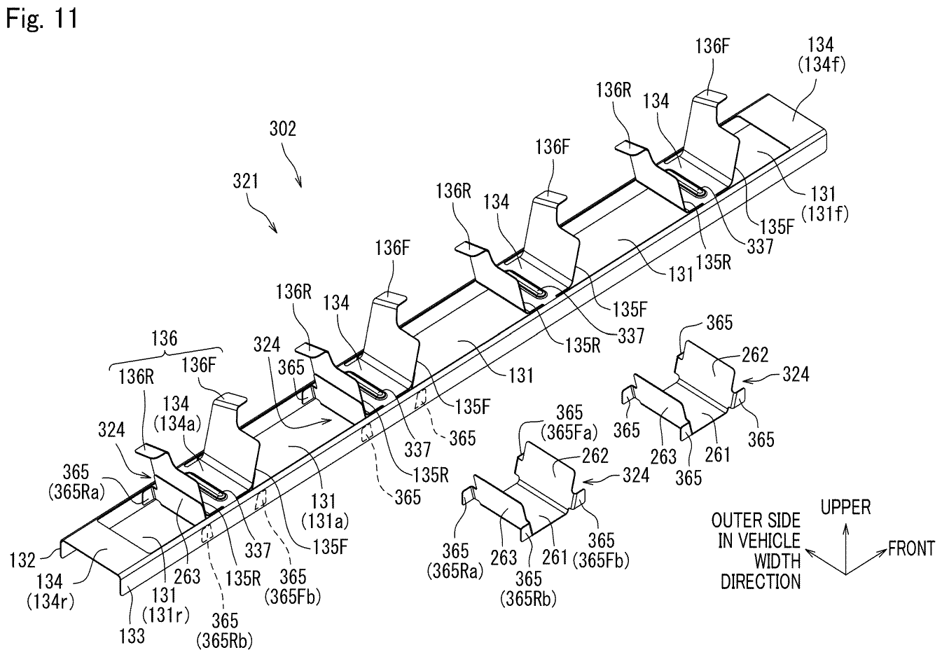

Next, a side sill 300 according to a third embodiment will be described with reference to FIGS. 9 to 11, focusing on differences from the above-described embodiments. The side sill main body 101 is similar to those of the first and second embodiments. As will be described below, structures of a base component 321 and a reinforcement component 324 are different from those in any one of the above-described embodiments. This makes a hollow portion 303 have a shape different from that in any one of the above-described embodiments.

The base component 321 has one or more bead portions 337 that project upward or downward and extend in the vehicle width direction on at least one of the plurality of horizontal plate portions 134. Except for this, the base component 321 has the through-hole 131, the first vertical plate portion 132, the second vertical plate portion 133, the horizontal plate portion 134, the flange portion 135, and the tab portion 136 in the same manner as in the first embodiment and the second embodiment.

In the present embodiment, the plurality of bead portions 337 are provided in a one-to-one correspondence with the plurality of horizontal plate portions 134. Each bead portion 337 projects upward at a central portion of the corresponding horizontal plate portion 134 in the vehicle length direction and linearly extends in the vehicle width direction.

Similarly to the second embodiment, the reinforcement component 324 has the web portion 261, the front wall portion 262, and the rear wall portion 263, but does not have the raised bottom portion 264 unlike the second embodiment. Instead, the reinforcement component 324 according to the present embodiment has a plurality of tab portions 365.

The plurality of tab portions 365 include an outer front tab portion 365Fa projecting in the vehicle length direction from an outer end edge of the front wall portion 262 in the vehicle width direction, and an outer rear tab portion 365Ra projecting in the vehicle length direction from an outer end edge of the rear wall portion 263 in the vehicle width direction. The outer front tab portion 365Fa and the outer rear tab portion 365Ra project away from each other in the vehicle length direction. Similarly, an inner front tab portion 365Fb and an inner rear tab portion 365Rb are provided at inner end edges of the front wall portion 262 and the rear wall portion 263 in the vehicle width direction, respectively.

A plate thickness direction of the tab portion 365 is oriented in the vehicle width direction. The outer front tab portion 365Fa and the outer rear tab portion 365Ra overlap the inner surface of the first vertical plate portion 132 and are welded to the outer wall 111 together with the first vertical plate portion 132. The inner front tab portion 365Fb and the inner rear tab portion 365Rb overlap the inner surface of the second vertical plate portion 133 and are bonded to the second vertical plate portion 133. In a case where the second vertical plate portion 133 is welded to the inner wall 112, the inner front tab portion 365Fb and the inner rear tab portion 365Rb may be simultaneously welded to the inner wall 112.

In this manner, the bead portion 337 is provided on at least one of the plurality of horizontal plate portions 134, thereby improving the stiffness of the horizontal plate portion 134. The tab portions 365 are provided on the reinforcement component 324, thereby improving the bonding strength of the reinforcement component 324 to the base component 321. This results in improvement in the bonding strength of the base component 321 to the side sill main body 101.

### Fourth Embodiment

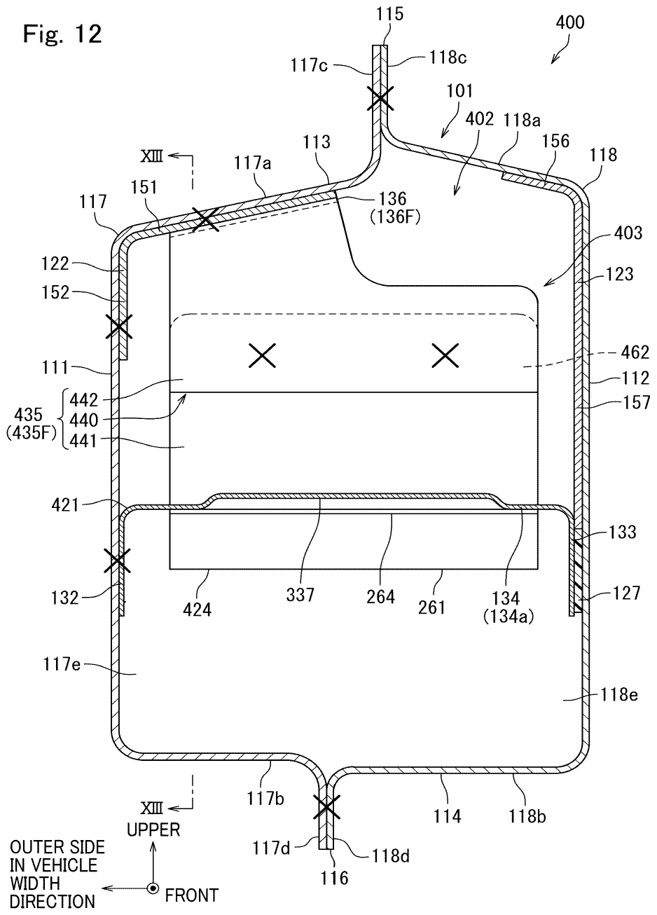

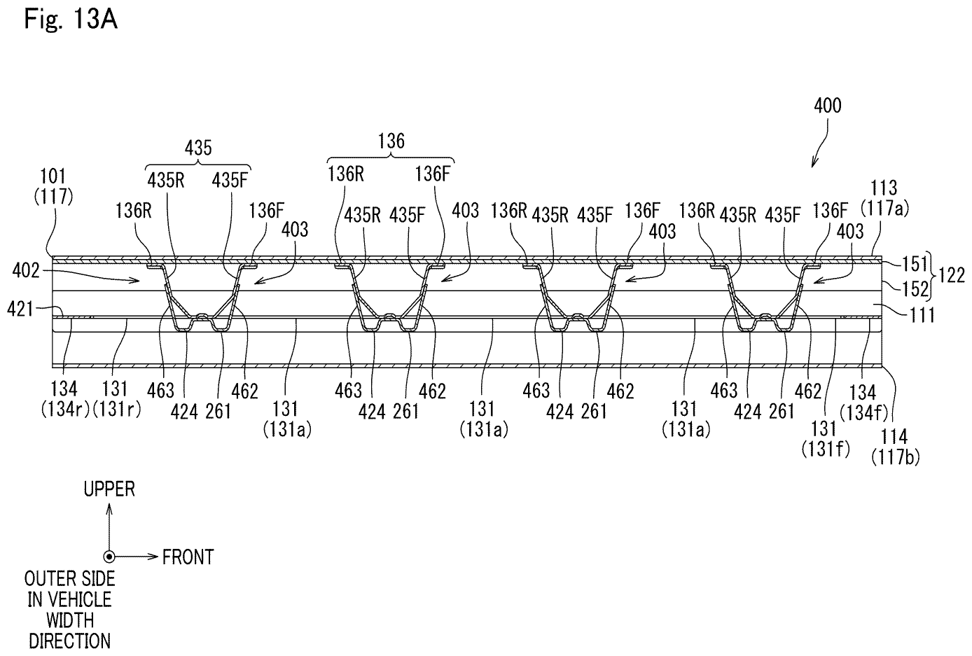

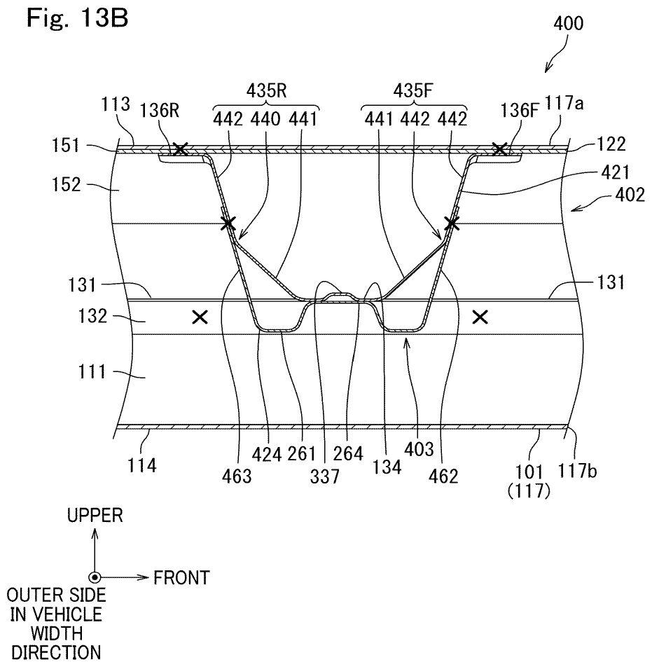

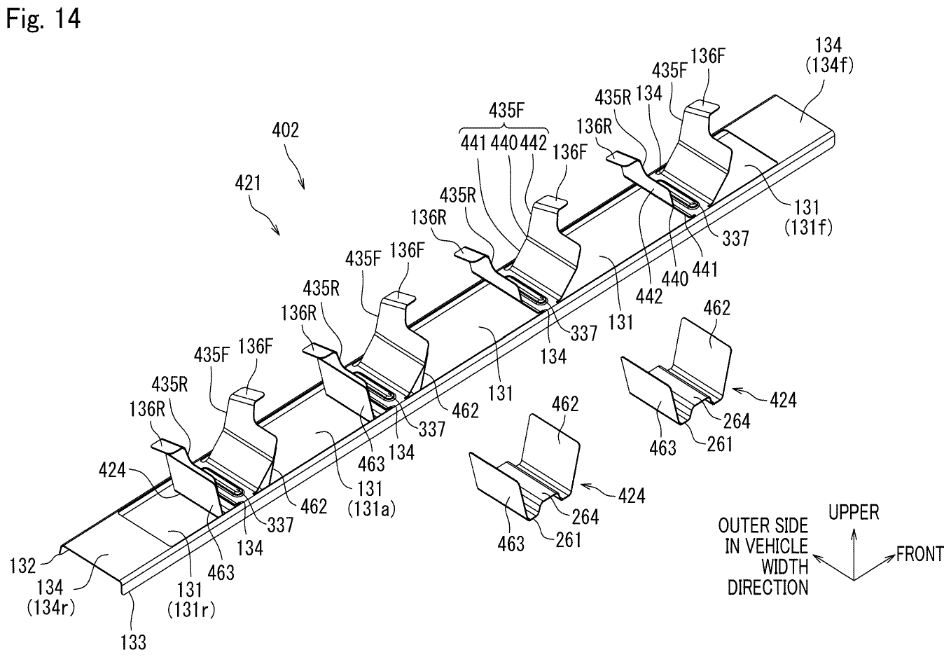

Next, a side sill 400 according to a fourth embodiment will be described with reference to FIGS. 12 to 14, focusing on differences from the above-described embodiments. The side sill main body 101 is similar to those of the first to third embodiments. As will be described below, structures of a base component 421 and a reinforcement component 424 are different from those in any one of the above-described embodiments. This makes a hollow portion 403 have a shape different from that in any one of the above-described embodiments.

A flange portion 435 of the base component 421 has one or more folding portions 440 between a lower end continuous with the horizontal plate portion 134 and an upper end reaching the inner surface of the upper wall 113 of the side sill main body 101. In the present embodiment, similarly to the above-described embodiments, the flange portion 435 includes a front flange portion 435F and a rear flange portion 435R. Each of the flange portions 435F and 435R has one folding portion 440F or 440R between an upper end and a lower end.

The front flange portion 435F has a first standing portion 441 extending upward from the lower end, and a second standing portion 442 extending upward from an upper end of the first standing portion 441 while being inclined with respect to an extending direction of the first standing portion 441. A lower end of the first standing portion 441 is continuous with an upper end of the second standing portion 442 at the folding portion 440. The first standing portion 441 extends obliquely toward the outer side in the vehicle length direction (a front side in the front flange portion 435F) as the first standing portion extends upward. The second standing portion 442 has a smaller inclination in the vehicle length direction with respect to the up-down direction than the first standing portion 441. In this manner, the folding portion 440 is formed to be angular due to the difference in gradient between the first standing portion 441 and the second standing portion 442.

Also in the present embodiment, the front flange portion 435F and the rear flange portion 435R are symmetrical in the front-rear direction. Similarly to the front flange portion 435F, the rear flange portion 435R also has a first standing portion 441 and a second standing portion 442. The tab portions 136F and 136R are provided at an upper end portion of the second standing portion 442 and are bonded to the upper wall 113 in the same manner as in the above-described embodiments.

In the present embodiment, this causes each of the hollow portions 403 to be demarcated by the horizontal plate portion 134, the first standing portion 441 of the front flange portion 435F, the second standing portion 442 of the front flange portion 435F, the first standing portion 441 of the rear flange portion 435R, the second standing portion 442 of the rear flange portion 435R, and the upper wall 113. Each hollow portion 403 has a hexagonal cross section when viewed in the vehicle width direction.

In this manner, the flange portion 435 has the folding portion 440, thereby causing the impact to be transmitted inward in the vehicle width direction via the plurality of standing portions 441 and 442 divided by the folding portion 440, when the impact is applied to the outer wall 111. Therefore, the impact absorption performance is improved in the tubular structure. In addition, each of the front flange portion 435F and the rear flange portion 435R have one of the folding portions 440, thereby causing each of the hollow portions 403 to have a hexagonal cross-sectional shape, and enabling high impact absorption performance or strength to be obtained.

The reinforcement component 424 is basically similar to that of the second embodiment. The front wall portion 462 overlaps an outer surface of the second standing portion 442 of the first standing portion 441 and the second standing portion 442 of the front flange portion 435F and is bonded to the second standing portion 442. The second standing portion 442 is located above the first standing portion 441, and an extending direction thereof is closer to the up-down direction than that of the first standing portion 441. Since the front wall portion 462 according to the present embodiment is bonded to the second standing portion 442 as described above, the front wall portion 462 is longer in the up-down direction than that of the second embodiment. The same applies to the rear wall 463. This enables a width (length in the vehicle length direction) of the web portion 261 of the reinforcement component 424 to be maintained wide, and enables the strength of the reinforcement component 424 to be maintained.

### Fifth Embodiment

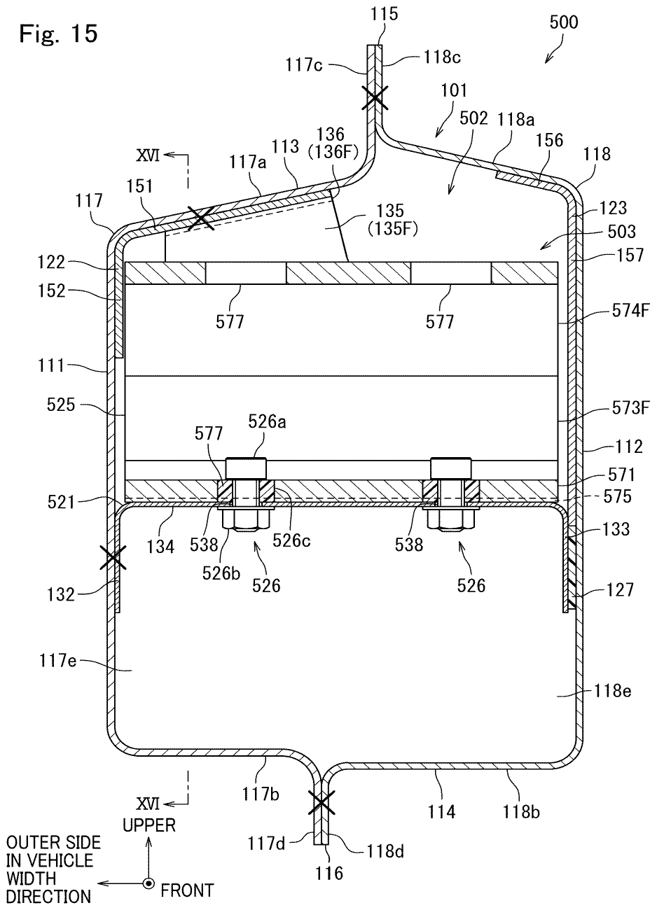

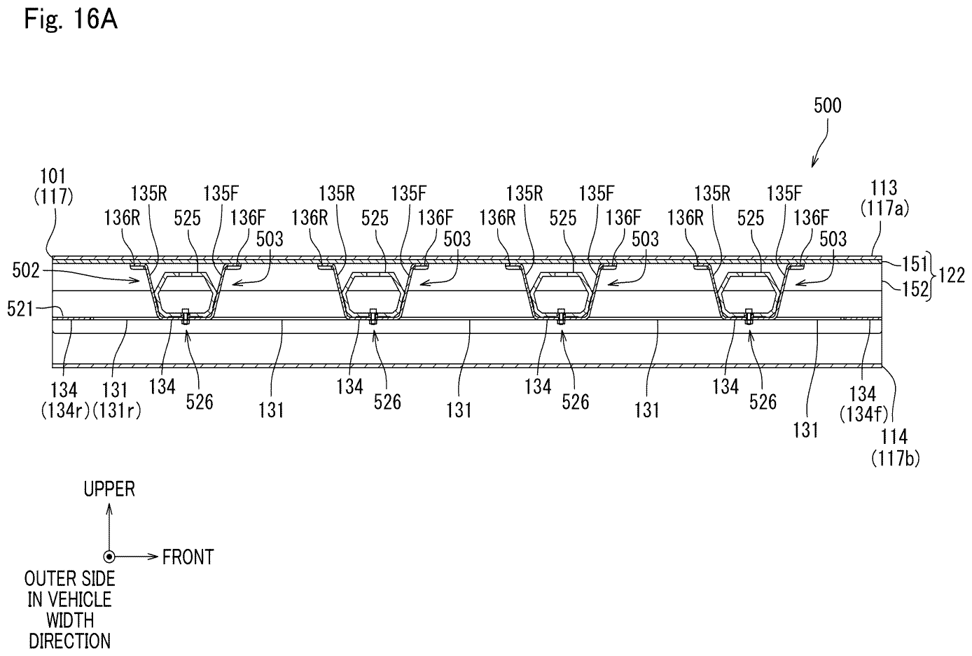

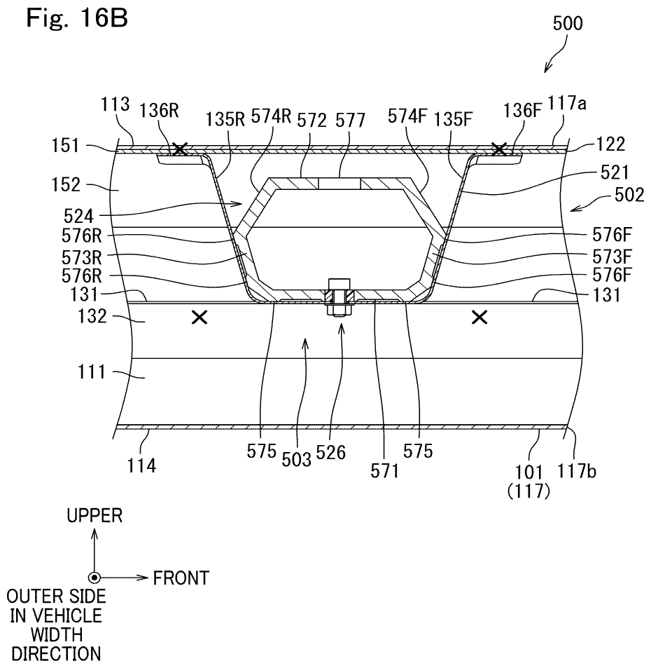

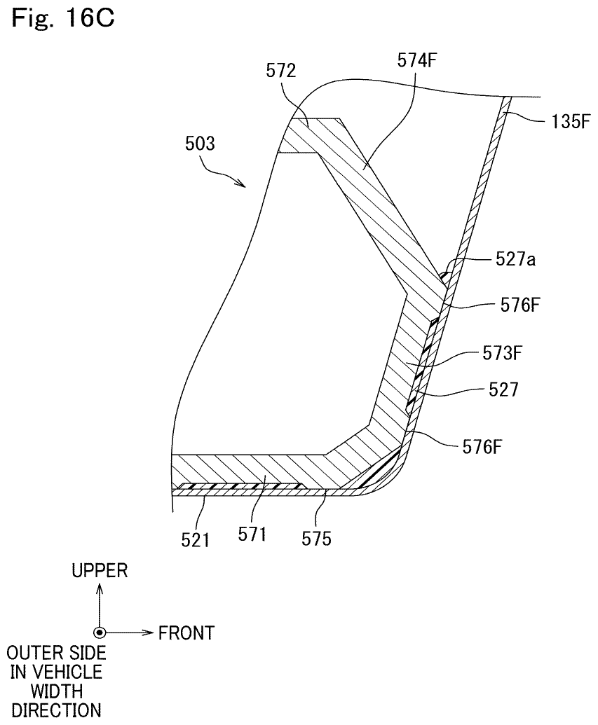

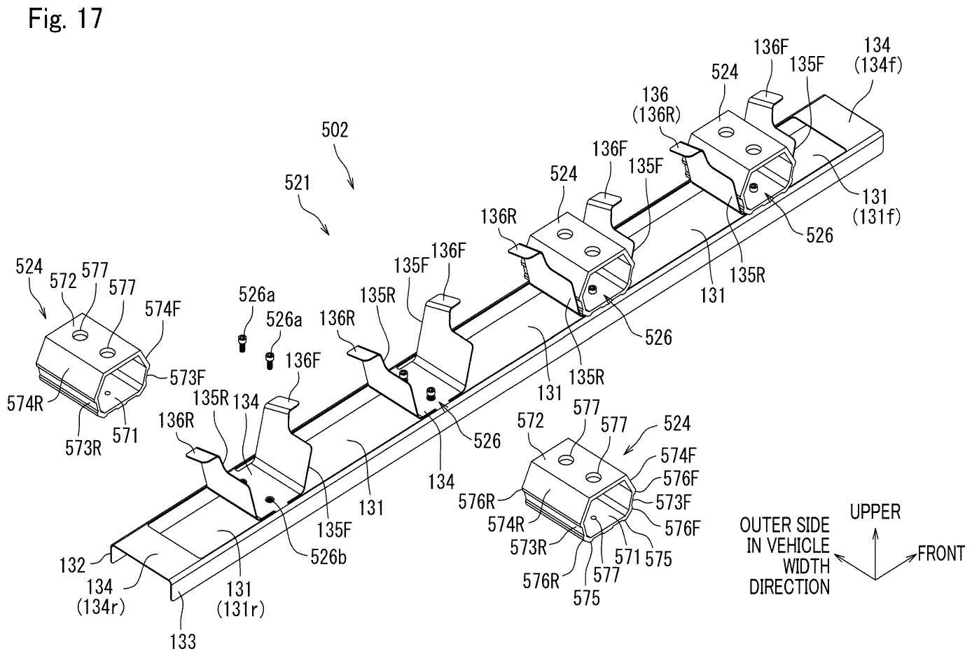

Next, a side sill 500 according to a fifth embodiment will be described with reference to FIGS. 15 to 17, focusing on differences from the above-described embodiments. The side sill main body 101 is similar to those of the first to fourth embodiments. The present embodiment is different from any one of the above-described embodiments in that an energy absorbing structure 502 includes a tubular component 525 instead of the reinforcement component as in the second to fourth embodiments. Although a base component 524 is similar to that of the first embodiment, a structure for attaching the tubular component 525 is added unlike any one of the above-described embodiments. This makes a hollow portion 503 have a shape different from that in any one of the above-described embodiments.

The base component 521 has the plurality of horizontal plate portions 134 and the plurality of flange portions 135 corresponding to the horizontal plate portions, similarly to the first embodiment, and each flange portion 135 includes a front flange portion 135F and a rear flange portion 135R, and each of the front flange portion 135F and the rear flange portion 135R does not have a folding portion similarly to the first to third embodiments.

A plurality of tubular components 525 are provided in a one-to-one correspondence with the plurality of flange portions 135. Each tubular component 525 is held by the flange portion 135 in the state of extending in the vehicle width direction. Each tubular component 525 has a closed cross section when viewed in the vehicle width direction.

In the present embodiment, just as an example, a cross-sectional shape of the tubular component 525 is a hexagonal shape. The tubular component 525 has a bottom wall 571, a pair of lower walls 573F and 573R extending upward from both edge portions of the bottom wall 571 in the vehicle length direction, a pair of upper walls 574F and 574R continuously extending upward from upper ends of the pair of lower walls 573F and 573R, and an upper wall 572 connecting upper ends of the pair of upper walls 574F and 574R to each other in the vehicle length direction. The bottom wall 571 is disposed parallel to the horizontal plate portion 134 and is supported on the horizontal plate portion 134. The pair of lower walls 573F and 573R are parallel to the pair of flange portions 135F and 135R, respectively, in a state in which the bottom wall 571 is supported on the horizontal plate portion 134 in a parallel state to each other. The pair of lower walls 573F and 573R extend along the pair of flange portions 135F and 135R on the inner surface side of the pair of flange portions 135F and 135R.

The base component 521 (and a blank plate thereof) is press-formed from the same type of metal material as that of the side sill main body 101, while the tubular component 525 is made of a different type of metal material from those of the side sill main body 101 and the base component 521. In the present embodiment, the base component 521 and the side sill main body 101 are press-formed from an iron-based metal material, whereas the tubular component 525 is made of a non-ferrous metal material, particularly, a light metal such as an aluminum alloy or a magnesium alloy.

When a contact area of the tubular component 525 with the base component 521 or the side sill main body 101 is large, wear of the tubular component 525 is accelerated by the electrochemical corrosion. In addition, since the materials are different, it is difficult to apply metallurgical bonding such as welding to the bonding of the tubular component 525 to the base component 521 or the side sill main body 101.

Hence, the bottom wall 571 of the tubular component 525 has a lower ridge portion 575 that partially projects downward. The lower ridge portion 575 protrudes downward when viewed in the vehicle width direction, and is in line contact with the upper surface of the horizontal plate portion 134 along a straight line extending in the vehicle length direction (in a cross section viewed in the vehicle width direction, the lower ridge portion 575 is drawn to be in contact with the horizontal plate portion 134 at one point). In the present embodiment, two lower ridge portions 575 are provided at two ends of the bottom wall 571 in the vehicle length direction. Therefore, most of a lower surface of the bottom wall 571 is separated upward from the upper surface of the horizontal plate portion 134.

A lower wall 573F on a front side of the tubular component 525 has a side ridge portion 576F that partially projects outward (frontward) in the vehicle length direction. The side ridge portion 576F protrudes frontward when viewed in the vehicle width direction, and is in line contact with the inner surface of the front flange portion 135F along a straight line extending in the vehicle length direction. In the present embodiment, two side ridge portions 576F are provided at an upper end portion and a lower end portion, respectively, of the lower wall 573F on the front side. Therefore, most of an outer surface (front surface) of the lower wall 573F is separated rearward from the inner surface (rear surface) of the flange portion 135F. Similarly, the lower wall 573R on the rear side also has a side ridge portion 576R that partially projects outward (rearward) in the vehicle length direction.

In this manner, most of a part of the tubular component 525 taken in by the base component 521 to be held by the flange portion 135 is not in direct contact with the base component 521 due to the ridge portions 575, 576F, and 576R. Hence, even if a material different from the material of the base component 521 is used for the tubular component 525, the electrochemical corrosion of the tubular component 525 can be avoided.

Each tubular component 525 is mechanically bonded to the corresponding horizontal plate portion 134 by using a fastening structure 526. The horizontal plate portion 134 has a bolt insertion hole 538 penetrating the horizontal plate portion 134 in the up-down direction. The fastening structure 526 includes a bolt 526a and a nut 526b. As illustrated in the drawings, the bolt 526a may be inserted downward from the inside of the tubular component 525 and screwed into the nut 526b placed on the lower surface side of the horizontal plate portion 134. The tubular component 525 may also have a through-hole into which the bolt 526a is inserted, and a resin collar 526c may be provided in a through-hole 577 in order to avoid direct contact between the bolt 526a and the tubular component 525. The bolt 526a may be inserted upward from the lower surface side of the horizontal plate portion 134, and in this case, the nut 526b is placed inside the tubular component 525.

In addition, before the tubular component 525 is fitted in the flange portion 135, an adhesive 527 is applied to the inner surface of the flange portion 135 (the rear surface of the front flange portion 135F and the front surface of the rear flange portion 135R). The side ridge portions 576F and 576R are mechanically bonded to the flange portion 435 with the adhesive 527. The adhesive 527 not only bonds the tubular component 525 and the base component 521, but also serves as electrical insulation between the tubular component 525 and the base component 521. It is possible to prevent electrochemical corrosion of the tubular component 525 and improve the bonding strength of the tubular component 525 to the base component 521. Further, a large amount of the adhesive 527 is applied in advance, thereby allowing a surplus portion 527a of the adhesive 527 to leak from an upper opening of a clearance between the tubular component 525 and the base component 521 and be solidified such that the clearance is sealed. Foreign matter such as water can be prevented from infiltrating the clearance, and a service life of the energy absorbing structure 502 is prolonged.

In this manner, the tubular component 525 is provided in the energy absorbing structure 502, thereby causing a closed cross section demarcated by the tubular component 525 to be added to the hollow portion 503, and enabling high impact absorption performance to be obtained in the energy absorbing structure 502. In addition, the mechanical bonding is applied to the bonding of the tubular component 525 and the base component 521, thus allowing, as a material of the tubular component 525, a metal material different from those of the side sill main body 101 and the base component 521 to be selected.

### Sixth Embodiment

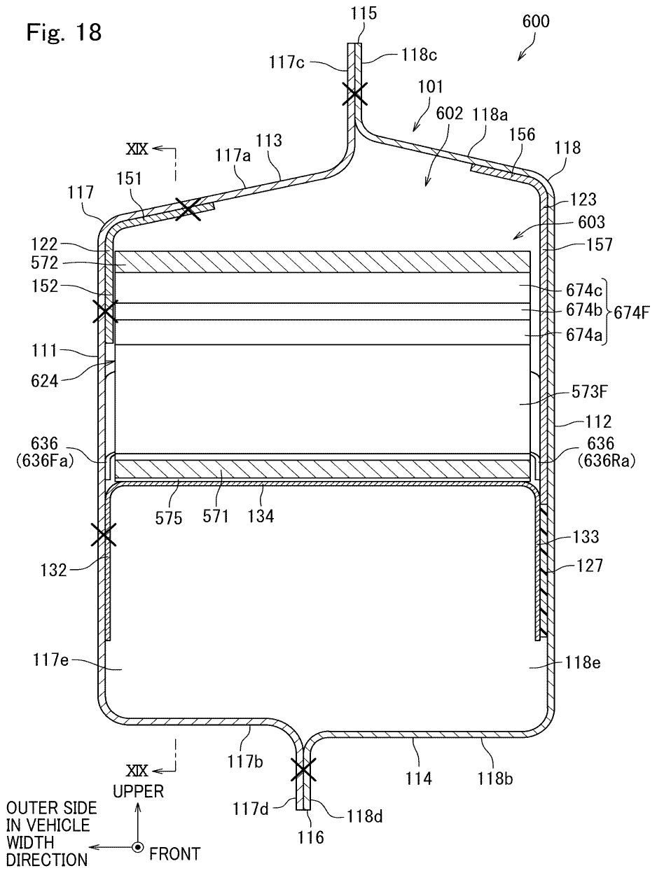

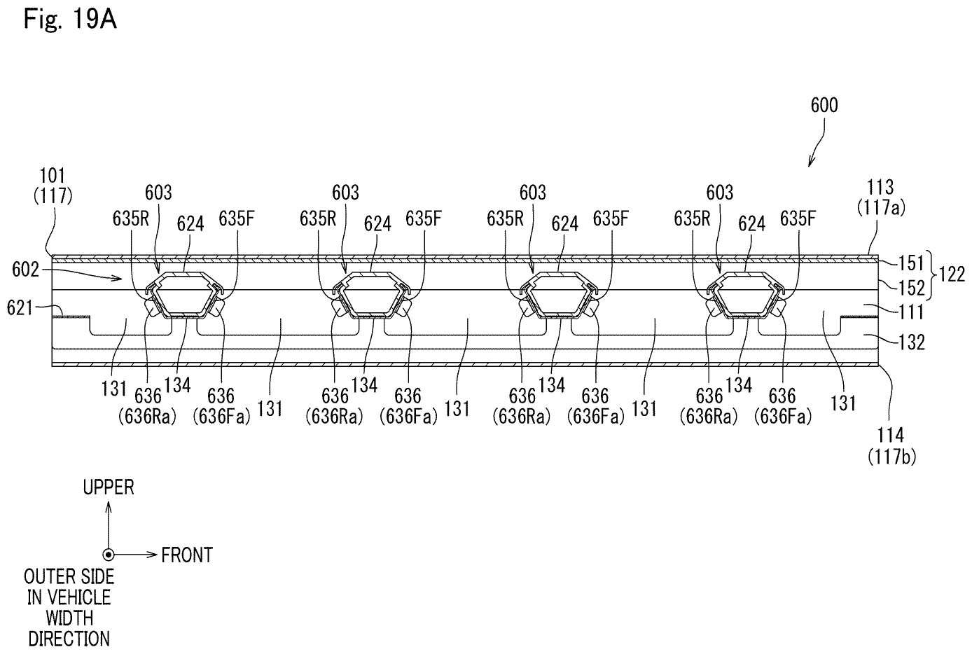

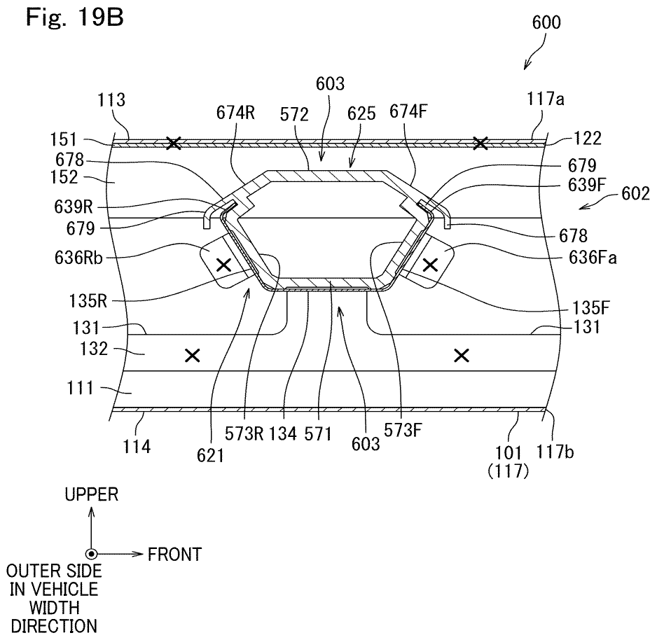

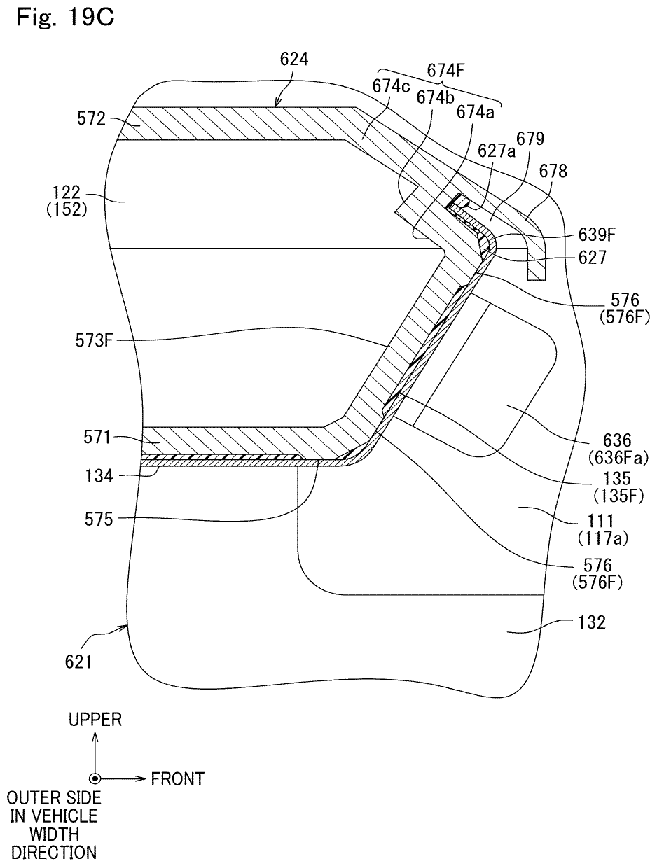

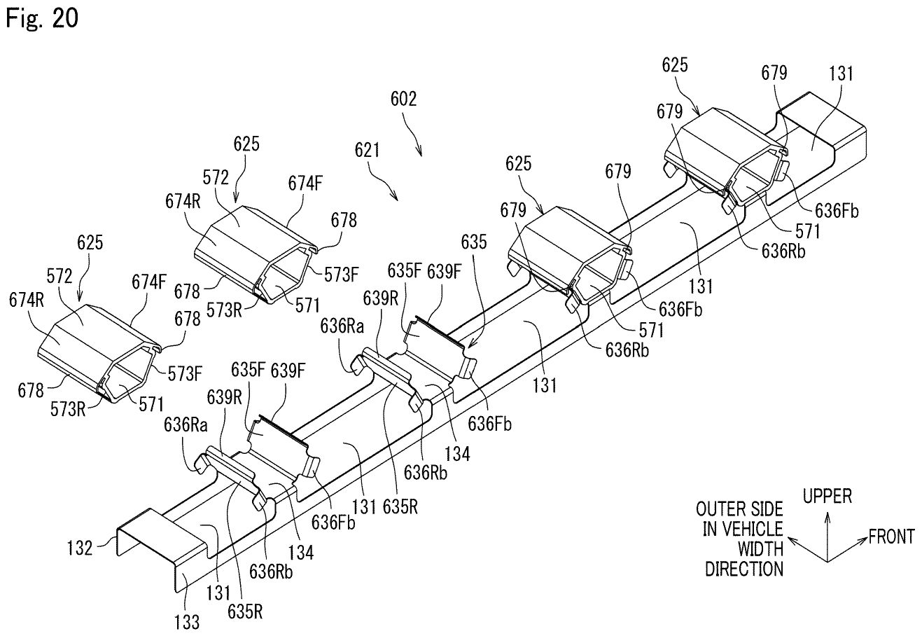

Next, a side sill 600 according to a sixth embodiment will be described with reference to FIGS. 18 to 20, focusing on differences from the above-described embodiments. The side sill main body 101 is similar to those of the first to fifth embodiments. An energy absorbing structure 602 according to the present embodiment is similar to that of the fifth embodiment in that the energy absorbing structure 602 includes the tubular component 525 instead of a reinforcement component. However, unlike any one of the above-described embodiments, in a base component 621 according to the present embodiment, a tab portion 636 is not provided not at an upper end portion of a flange portion 635 but is provided at two end portions thereof in the vehicle width direction, and a flange portion 635 does not reach the upper wall 113 of the side sill main body 101. This makes a hollow portion 603 have a shape different from that in any one of the above-described embodiments.

Similarly to the fifth embodiment, the base component 621 has the plurality of through-holes 131, the first vertical plate portion 132, the second vertical plate portion 133, the plurality of horizontal plate portions 134, and a plurality of flange portions 635, and a front flange portion 635F and a rear flange portion 635R of each of the flange portions 635 do not have a folding portion. The tab portion 636 includes an outer front tab portion 636Fa and an inner front tab portion 636Fb projecting frontward from an outer end edge and an inner end edge, respectively, of the front flange portion 635F in the vehicle width direction, and an outer rear tab portion 636Ra and an inner rear tab portion 636Rb projecting rearward from an outer end edge and an inner end edge, respectively, of the rear flange portion 135R in the vehicle width direction.

Unlike any one of the above-described embodiments, the front flange portion 635F and the rear flange portion 635R do not reach the inner surface of the upper wall 113 of the side sill main body 101 and terminate below the upper wall 113 of the side sill main body 101. Instead, a pair of front and rear engagement pieces 639F and 639R are provided at upper end portions of the front flange portion 635F and the rear flange portion 635R. The engagement pieces 639F and 639R extend from upper ends of the pair of flange portions 635F and 635R, respectively, to sides on which the engagement pieces face each other in the vehicle length direction.

On the other hand, similarly to the fifth embodiment, a tubular component 625 has the bottom wall 571, the upper wall 572, the pair of lower walls 573F and 573R, a pair of upper walls 674F and 674R, the lower ridge portion 575, and the side ridge portions 576F and 576R. The pair of upper walls 674F and 674R have respective steps in the up-down direction between the upper ends of the pair of lower walls 573 and end portions thereof in the vehicle length direction. Each of the upper walls 674F and 674R has a lower step wall 674a extending upward and inward in the vehicle length direction from the lower walls 673F and 673R, a riser portion 674b extending upward from an upper end of the lower step wall 674a, and an upper step wall 674c that extends upward and inward in the vehicle length direction from an upper end of the riser portion 674b and is connected to the upper wall 572. The upper step wall 674c has an extension portion 678 extending outward in the vehicle length direction with respect to the riser portion 674b. The extension portion 678 projects outward in the vehicle length direction from each of the upper walls 674F and 674R. The lower step wall 674a, the riser portion 674b, and the extension portion 678 demarcate a slit 679 that extends in the vehicle width direction, and is open at both ends in the vehicle width direction. A distal end portion of the extension portion 678 is bent downward, and an outer side of the slit 679 in the vehicle length direction is covered with the distal end portion.

When the tubular component 625 is attached to the base component 621, the tubular component 625 is inserted between the pair of flange portions 635F and 635R in the vehicle width direction. In this case, the engagement pieces 639F and 639R are received in the slits 679, the pair of lower walls 573F and 573R are close to inner surfaces of the pair of flange portions 635, and the bottom wall 571 is close to the upper surface of the horizontal plate portion 134. In order to avoid direct contact of the engagement pieces 639F and 639R with the upper walls 674F and 674R, the slits 679 are filled with the adhesive 627 in advance. This enables the tubular component 625 to be mechanically bonded to the base component 621 strongly by an adhesive force of the adhesive 627 and the engagement of the engagement pieces 639 in the slits 679 without using the fastening structure as in the fifth embodiment. Further, similarly to the fifth embodiment, a large amount of the adhesive 627 is applied in advance, thereby enabling a sealing effect to be obtained by a surplus portion 627a of the adhesive 627.

### Modification Examples

Although the embodiments have been described hitherto, the above-described configurations can be appropriately added, modified, and/or removed within the scope of the present disclosure.

Although the flange portion includes the pair of front and rear flange portions, the flange portion may include one flange portion. The plurality of horizontal plate portions are connected to the first vertical plate portion and the second vertical plate portion, but the second vertical plate portion can be omitted. The first vertical plate portion is a part bonded to the outer wall to which the impact at the time of occurrence of a side collision is applied. Hence, in a case where the plurality of horizontal plate portions are integrated with each other via either the first vertical plate portion or the second vertical plate portion, the first vertical plate portion is not used for the integration, and the first vertical plate portion is bonded to the outer wall, thereby enabling higher impact absorption performance to be obtained in the energy absorbing structure.

In the third embodiment and the fourth embodiment, the reinforcement component may be omitted. In the fifth embodiment and the sixth embodiment, the tubular component may be omitted. Both the reinforcement component and the tubular component may be attached to the base component.

The reinforcement component may have both the raised bottom portion exemplified in the second embodiment and the fourth embodiment and the tab portion exemplified in the third embodiment. In addition, the reinforcement component may not have either the raised bottom portion or the tab portion.

This disclosure may involve the following aspects.

### (Aspect 1)

A side sill structure comprising:
a side sill main body extending in a vehicle length direction; and
an energy absorbing structure that forms a plurality of hollow portions, the plurality of hollow portions individually extending in a vehicle width direction inside the side sill main body and being arranged at intervals in the vehicle length direction,
the side sill main body including:
   an outer wall on an outer side in the vehicle width direction;
   an inner wall on an inner side in the vehicle width direction: and
   an upper wall connecting upper ends of the outer wall and the inner wall to each other in the vehicle width direction,
the energy absorbing structure including a base component, and
the base component including:
   a plurality of through-holes arranged in the vehicle length direction;
   a first vertical plate portion that extends in the vehicle length direction on the outer side in the vehicle width direction with respect to the plurality of through-holes and is bonded to an inner surface of the outer wall;
   a plurality of horizontal plate portions that individually extend in the vehicle width direction from the first vertical plate portion and between two adjacent through-holes among the plurality of through-holes and that are arranged in the vehicle length direction; and
   a plurality of flange portions each of which are punched and bent upward from a corresponding one of the plurality of horizontal plate portions, the plurality of flange portions being arranged at intervals in the vehicle length direction.

### (Aspect 2)

The side sill structure according to Aspect 1, wherein
the base component is formed from a same kind of metal material as the side sill main body, and
the first vertical plate portion is welded to the outer wall.

### (Aspect 3)

The side sill structure according to Aspect 1 or 2, wherein
a plate thickness direction of the first vertical plate portion is oriented in the vehicle width direction, and
the first vertical plate portion overlaps the inner surface of the outer wall.

### (Aspect 4)

The side sill structure according to any of Aspects 1 to 3, wherein the base component further has a second vertical plate portion that extends in the vehicle length direction on the inner side in the vehicle width direction with respect to the plurality of through-holes, is continuous to the plurality of horizontal plate portions, and overlaps an inner surface of the inner wall.

### (Aspect 5)

The side sill structure according to any of Aspects 1 to 4, wherein at least one of the plurality of horizontal plate portions has a bead portion that projects upward or downward and extends in the vehicle width direction.

### (Aspect 6)

The side sill structure according to any of Aspects 1 to 5, wherein
each of the flange portions has, at an upper end portion thereof, a tab portion, and
the tab portion has an upper surface that overlaps an inner surface of the upper wall.

### (Aspect 7)

The side sill structure according to any of Aspects 1 to 6, wherein each of the flange portions has one or more folding portions between a lower end and an upper end of each of the flange portions.

### (Aspect 8)

The side sill structure according to any of Aspects 1 to 7, wherein each of the flange portions includes a front flange portion extending upward from a front edge portion of each of the horizontal plate portions, and a rear flange portion extending upward from a rear edge portion of each of the horizontal plate portions.

### (Aspect 9)

The side sill structure according to Aspect 8, wherein the front flange portion and the rear flange portion are inclined to be separated from each other in the vehicle length direction as the front and rear flange portions extend upward.

### (Aspect 10)

The side sill structure according to Aspect 9, wherein
each of the front flange portion and the rear flange portion has one folding portion between a lower end and an upper end of each of the front and rear flange portions, and
each of the plurality of tubular structures is demarcated by each of the horizontal plate portions, the front flange portion, the rear flange portion, and the upper wall, and has a hexagonal cross section when viewed in the vehicle width direction.

### (Aspect 11)

The side sill structure according to any of Aspects 1 to 10, wherein
the energy absorbing structure further includes an outer patch having an upper cover portion that covers an upper portion of each of the flange portions, and a side cover portion that extends downward from a side end edge of the upper cover portion and covers a side portion of each of the flange portions in the vehicle width direction, and
the side cover portion is welded to the outer wall, and the upper cover portion is welded to the upper wall.

### (Aspect 12)

The side sill structure according to any of Aspects 1 to 11, wherein the energy absorbing structure further has a reinforcement component bonded to each of the flange portions.

### (Aspect 13)

The side sill structure according to Aspect 12, wherein
the reinforcement component has an end portion on the outer side in the vehicle width direction at which a tab portion is provided,
a plate thickness direction of the first vertical plate portion and a plate thickness direction of the tab portion are oriented in the vehicle width direction, and
the first vertical plate portion and the tab portion overlap the inner surface of the outer wall and are bonded to the outer wall.

### (Aspect 14)

The side sill structure according to Aspect 12 or 13, wherein each of the flange portions includes a front flange portion extending upward from a front edge portion of each of the horizontal plate portions, and a rear flange portion extending upward from a rear edge portion of each of the horizontal plate portions, and
the reinforcement component has
   a front wall portion that passes through one of the through-holes adjacent to a front side of the front flange portion, extends in an up-down direction, and is bonded to an outer surface of the front flange portion,
   a rear wall portion that passes through one of the through-holes adjacent to a rear side of the rear flange portion, extends in the up-down direction, and is bonded to an outer surface of the rear flange portion, and
   a web portion connecting lower ends of the front wall portion and the rear wall portion to each other in the vehicle length direction, below each of the horizontal plate portions.

### (Aspect 15)

The side sill structure according to Aspect 14, wherein
the web portion has a raised bottom portion that projects upward and extends in the vehicle width direction, and
the raised bottom portion is welded to each of the horizontal plate portions.

### (Aspect 16)

The side sill structure according to any of Aspects 1 to 15, wherein
the energy absorbing structure further has a plurality of tubular components that individually extends in the vehicle width direction and has a closed cross section when viewed in the vehicle width direction, and
each of the plurality of tubular components is bonded to at least one of the horizontal plate portions or the flange portions.

### (Aspect 17)

The side sill structure according to Aspect 16, wherein
the base component is formed from a same kind of metal material as the side sill main body,
the tubular components are formed from a kind of metal material different from materials of the side sill main body and the base component, and
the base component is welded to the side sill main body, and the tubular components are mechanically bonded to the base component.

This application claims priority based on Japanese Patent Application No. 2023-016261 filed on Feb. 6, 2023. Japanese Patent Application No. 2023-016261 is incorporated herein by reference.

### REFERENCE SIGNS LIST

1 Vehicle
2 Vehicle body
3 Battery
100, 200, 300, 400, 500, 600 Side sill
101 Side sill main body
102, 202, 302, 402, 502, 602 Energy absorbing structure
111 Outer wall
112 Inner wall
113 Upper wall
114 Lower wall
115 Upper flange
116 Lower flange
117 Outer side sill
117a Outer upper wall
117b Outer lower wall
117c Outer upper flange
117d Outer lower flange
117e Space
118 Inner side sill
118a Inner upper wall
118b Inner lower wall
118c Inner upper flange
118d Inner lower flange
118e Space
121, 321, 421, 521, 621 Base component
122 Outer patch
123 Inner patch
224, 324, 424 Reinforcement component
525, 625 Tubular component
526 Fastening structure
127, 527 Adhesive
130 Blank plate
130a Initial through-hole
131 Through-hole
132 First vertical plate portion
133 Second vertical plate portion
134 Horizontal plate portion
134a Intermediate horizontal plate portion
134b Front end horizontal plate portion
134c Rear end horizontal plate portion
135, 435 Flange portion
135a Projecting portion
135F, 435F Front flange portion
135R, 435R Rear flange portion
136, 636 Tab portion
136F Front tab portion
136R Rear tab portion
636Fa Outer front tab portion
636Fb Inner front tab portion
636Ra Outer rear tab portion
636Rb inner rear tab portion
337 Bead portion
538 Bolt insertion hole
639F, 639R Engagement piece
440 Folding portion
441 First standing portion
442 Second standing portion
151 Upper cover portion
152 Side cover portion
156 Upper cover portion
157 Side cover portion
261 Web portion
262, 462 Front wall portion
263, 463 Rear wall portion
264 Raised bottom portion
365 Tab portion
571 Bottom wall
572 Upper wall
573F, 573R Lower wall
574F, 574R, 674F, 674R Upper wall
674a Lower step wall
674b Riser portion
674c Upper step wall
575 Lower ridge portion
576F, 576R Side ridge portion
577 Through-hole
678 Extension portion
679 Slit

1. A side sill structure comprising:
a side sill main body extending in a vehicle length direction; and
an energy absorbing structure that forms a plurality of hollow portions, the plurality of hollow portions individually extending in a vehicle width direction inside the side sill main body and being arranged at intervals in the vehicle length direction,
the side sill main body including:
an outer wall on an outer side in the vehicle width direction;
an inner wall on an inner side in the vehicle width direction: and
an upper wall connecting upper ends of the outer wall and the inner wall to each other in the vehicle width direction,
the energy absorbing structure including a base component, and
the base component including:
a plurality of through-holes arranged in the vehicle length direction;
a first vertical plate portion that extends in the vehicle length direction on the outer side in the vehicle width direction with respect to the plurality of through-holes and is bonded to an inner surface of the outer wall;
a plurality of horizontal plate portions that individually extend in the vehicle width direction from the first vertical plate portion and between two adjacent through-holes among the plurality of through-holes and that are arranged in the vehicle length direction; and
a plurality of flange portions each of which is punched and bent upward from a corresponding one of the plurality of horizontal plate portions, the plurality of flange portions being arranged at intervals in the vehicle length direction.

2. The side sill structure according to claim 1, wherein
the base component is formed from a same kind of metal material as the side sill main body, and
the first vertical plate portion is welded to the outer wall.

3. The side sill structure according to claim 1, wherein
a plate thickness direction of the first vertical plate portion is oriented in the vehicle width direction, and
the first vertical plate portion overlaps the inner surface of the outer wall.

4. The side sill structure according to claim 1, wherein the base component further has a second vertical plate portion that extends in the vehicle length direction on the inner side in the vehicle width direction with respect to the plurality of through-holes, is continuous to the plurality of horizontal plate portions, and overlaps an inner surface of the inner wall.

5. The side sill structure according to claim 1, wherein at least one of the plurality of horizontal plate portions has a bead portion that projects upward or downward and extends in the vehicle width direction.

6. The side sill structure according to claim 1, wherein
each of the flange portions has, at an upper end portion thereof, a tab portion, and
the tab portion has an upper surface that overlaps an inner surface of the upper wall.

7. The side sill structure according to claim 1, wherein each of the flange portions has one or more folding portions between a lower end and an upper end of each of the flange portions.

8. The side sill structure according to claim 1, wherein each of the flange portions includes a front flange portion extending upward from a front edge portion of each of the horizontal plate portions, and a rear flange portion extending upward from a rear edge portion of each of the horizontal plate portions.

9. The side sill structure according to claim 8, wherein the front flange portion and the rear flange portion are inclined to be separated from each other in the vehicle length direction as the front and rear flange portions extend upward.

10. The side sill structure according to claim 9, wherein
each of the front flange portion and the rear flange portion has one folding portion between a lower end and an upper end of each of the front and rear flange portions, and
each of the plurality of tubular structures is demarcated by each of the horizontal plate portions, the front flange portion, the rear flange portion, and the upper wall, and has a hexagonal cross section when viewed in the vehicle width direction.

11. The side sill structure according to claim 1, wherein
the energy absorbing structure further includes an outer patch having an upper cover portion that covers an upper portion of each of the flange portions, and a side cover portion that extends downward from a side end edge of the upper cover portion and covers a side portion of each of the flange portions in the vehicle width direction, and
the side cover portion is welded to the outer wall, and the upper cover portion is welded to the upper wall.

12. The side sill structure according to claim 1, wherein the energy absorbing structure further has a reinforcement component bonded to each of the flange portions.

13. The side sill structure according to claim 12, wherein
the reinforcement component has an end portion on the outer side in the vehicle width direction at which a tab portion is provided,
a plate thickness direction of the first vertical plate portion and a plate thickness direction of the tab portion are oriented in the vehicle width direction, and
the first vertical plate portion and the tab portion overlap the inner surface of the outer wall and are bonded to the outer wall.

14. The side sill structure according to claim 12, wherein
each of the flange portions includes a front flange portion extending upward from a front edge portion of each of the horizontal plate portions, and a rear flange portion extending upward from a rear edge portion of each of the horizontal plate portions, and
the reinforcement component has
a front wall portion that passes through one of the through-holes adjacent to a front side of the front flange portion, extends in an up-down direction, and is bonded to an outer surface of the front flange portion,
a rear wall portion that passes through one of the through-holes adjacent to a rear side of the rear flange portion, extends in the up-down direction, and is bonded to an outer surface of the rear flange portion, and
a web portion connecting lower ends of the front wall portion and the rear wall portion to each other in the vehicle length direction, below each of the horizontal plate portions.

15. The side sill structure according to claim 14, wherein
the web portion has a raised bottom portion that projects upward and extends in the vehicle width direction, and
the raised bottom portion is welded to each of the horizontal plate portions.

16. The side sill structure according to claim 1, wherein
the energy absorbing structure further has a plurality of tubular components that individually extend in the vehicle width direction and have a closed cross section when viewed in the vehicle width direction, and
each of the plurality of tubular components is bonded to at least one of the horizontal plate portions or the flange portions.

17. The side sill structure according to claim 16, wherein
the base component is formed from a same kind of metal material as the side sill main body,
the tubular components are formed from a kind of metal material different from materials of the side sill main body and the base component, and
the base component is welded to the side sill main body, and the tubular components are mechanically bonded to the base component.
